(19) United States
(12) Patent Application Publication
(10) Pub. No.: US 2006/0126738 A1
(43) Pub. Date: Jun. 15, 2006

(54) Method, system and program product for a plurality of cameras to track an object using motion vector data

(75) Inventors: Charles Edward Boice, Endicott, NY (US); Adrian Stephen Butter, Binghamton, NY (US); Joseph George Schaefer, Berkshire, NY (US); Edward Francis Westermann, Endicott, NY (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/013,271

(22) Filed: Dec. 15, 2004

(51) Int. Cl. H04N 11/02; H04N 5/33; H04N 7/12; H04N 11/04; H04B 1/66

(52) U.S. Cl. 375/240.16; 348/168; 375/240.24

(57) ABSTRACT

A method, system and program product in accordance with the preferred embodiments use motion vector data to track an object moving between areas being monitored by a plurality of video cameras. Motion vector data are used to predict whether an object in a first field of view covered by a first camera system will enter a second field of view covered by a second camera system. If the prediction is that the object will enter the second field of view, tracking data are provided to the second camera system. The tracking data may include pan, tilt and/or zoom adjustment data, which may be provided to a PTZ adjustment mechanism of the second camera system, for example. Alternatively, or in addition, the tracking data may include pan/tilt motion vector data, zoom factor data and/or shrinkage/expansion data, which are provided to a motion tracking processor of the second camera system.

### CROSS-REFERENCE TO RELATED APPLICATION

This patent application is related to a pending U.S. patent application Ser. No. __/______ (docket no. ROC920040315US1), filed ______, entitled “METHOD, SYSTEM AND PROGRAM PRODUCT FOR A CAMERA TO TRACK AN OBJECT USING MOTION VECTOR DATA”, which is assigned to the assignee of the instant application.

### BACKGROUND OF THE INVENTION

1. Field of Invention

The present invention relates in general to the video processing field. More particularly, the present invention relates to a method, system and program product for a plurality of cameras to track an object using motion vector data.

2. Background Art

Video cameras are increasingly used to monitor sites for various purposes including security, surveillance, tracking, and reconnaissance. Because of the increased interest in security since the terrorist attacks of Sep. 11, 2001; extended business hours in stores, offices and factories; increased numbers of unattended facilities; and increased use of traffic monitoring, the demand for monitoring by video cameras is growing rapidly. Typically, one or more video cameras are located in areas to be monitored. The images taken by the video cameras are typically viewed and/or recorded at one or more monitoring stations, which may be remote from the areas to be monitored. The video cameras may be fixed and/or mobile. Similarly, the monitoring stations may be fixed and/or mobile. For example, video cameras may be fixedly mounted at several locations of an airport, e.g., along walkways, perimeter fences, runways, and gates. The images taken by the video cameras at the airport locations may be monitored at one or more monitoring stations. A fixedly-mounted video camera may have the ability to pan, tilt, and zoom its current field of view within an overall field of view. Alternatively, video cameras may be mounted for mobility on one or more reconnaissance aircraft or other vehicle, with each such aircraft or other vehicle traveling to cover a reconnaissance area. The images taken by the video cameras within the reconnaissance areas may be monitored at one or more monitoring stations. In addition to the mobility provided by the vehicle, a vehicle-mounted video camera may have the ability to pan, tilt, and zoom its current field of view within an overall field of view.

Typically, the ability to pan, tilt, and zoom a video camera is controlled by an operator in a monitoring station. The operator may notice or be alerted that an event of interest, e.g., unauthorized activity, has occurred in an area being monitored. The alert may be generated by a motion detecting apparatus using the output of the video camera or some other detector or sensor. For example, it is conventional to use a motion detecting apparatus that detects motion using motion vectors generated from the output of a video camera. Once aware that an event of interest has occurred, the operator may then cause the video camera covering the area in which the event has occurred to pan, tilt, and zoom to follow or track an object associated with the event. Typically, the operator controls the video camera to track the object using an input device, such as a mouse or joystick, which causes transmission of pan, tilt, and zoom adjustment commands to a pan, tilt, and zoom adjustment mechanism associated with the video camera. Because this is an open-loop system, tracking the object is difficult and requires a skilled operator. The difficulty increases as the object moves out of the area being monitored by the video camera and into another area being monitored by a second video camera.

### SUMMARY OF THE INVENTION

According to the preferred embodiments, a method, system and program product use motion vector data to track an object moving between areas being monitored by a plurality of video cameras. Motion vector data are used to predict whether an object in a first field of view covered by a first camera system will enter a second field of view covered by a second camera system. For example, motion vector data may be provided to a motion tracking processor of the first camera system at a macroblock level by an MPEG compression processor of the first camera system. Alternatively, motion vector data may be provided to a motion tracking processor of the first camera system at a pixel level by a pre-processor of the first camera system. If the prediction is that the object will enter the second field of view, tracking data are provided to the second camera system. The tracking data provided to the second camera system may include pan, tilt and/or zoom adjustment data, which may be provided to a PTZ adjustment mechanism of the second camera system, for example. Alternatively, or in addition, the tracking data provided to the second camera system may include pan/tilt motion vector data, zoom factor data and/or shrinkage/expansion data, which are provided to a motion tracking processor of the second camera system. Pan, tilt and/or zoom adjustment data may also be provided to a PTZ adjustment mechanism of the first camera system irrespective of the prediction of whether the object will enter the second field of view. Because the preferred embodiments use a closed loop system, tracking the object is made easier and does not require a skilled operator even as the object moves between areas being monitored by different cameras.

The foregoing and other features and advantages of the invention will be apparent from the following more particular description of the preferred embodiments of the invention, as illustrated in the accompanying drawings.

### BRIEF DESCRIPTION OF THE DRAWINGS

The preferred exemplary embodiments of the present invention will hereinafter be described in conjunction with the appended drawings, where like designations denote like elements.

FIG. 1 is a block diagram showing a system that allows a camera to track an object using motion vector data in accordance with the preferred embodiments.

FIG. 2 is a block diagram showing a computer system having a processor that corresponds to a motion tracking processor of FIG. 1.

FIG. 3 is a flow diagram showing a method that allows a camera to track an object using motion vector data in accordance with the preferred embodiments.

FIG. 4 illustrates a camera field of view in accordance with the preferred embodiments.

FIG. 5 illustrates a camera field progression in accordance with the preferred embodiments.

FIG. 6 illustrates a camera zoom out adjustment in accordance with the preferred embodiments.

FIG. 7 illustrates a camera zoom in adjustment in accordance with the preferred embodiments.

FIG. 8 is a flow diagram showing in more detail a method of computing camera pan and tilt adjustment data of FIG. 3.

FIG. 9 is a flow diagram showing in more detail a method of computing camera zoom adjustment data of FIG. 3.

FIG. 10 illustrates an example of net object contraction from field (n−1) to field (n) in accordance with the preferred embodiments.

FIG. 11 illustrates a multiple camera arrangement in accordance with the preferred embodiments.

FIG. 12 is a block diagram showing a system that allows a plurality of cameras to track an object using motion vector data in accordance with the preferred embodiments.

FIG. 13 is a block diagram showing a computer system having a system processor and motion tracking processors that correspond to those of FIG. 12.

FIG. 14 is a flow diagram showing a high level overview of a method that allows a plurality of cameras to track an object using motion vector data in accordance with the preferred embodiments.

FIG. 15 is a flow diagram showing in more detail a method performed by a video camera system of FIG. 12 and method of FIG. 14.

FIG. 16 is a flow diagram showing in more detail a method performed by a system processor of FIG. 12 and method of FIG. 14.

### DETAILED DESCRIPTION OF THE PREFERRED EMBODIMENTS

1. Overview

A method, system and program product in accordance with the preferred embodiments use motion vector data to track an object moving between areas being monitored by a plurality of video cameras. Motion vector data are used to predict whether an object in a first field of view covered by a first camera system will enter a second field of view covered by a second camera system. For example, motion vector data may be provided to a motion tracking processor of the first camera system at a macroblock level by an MPEG compression processor of the first camera system. Alternatively, motion vector data may be provided to a motion tracking processor of the first camera system at a pixel level by a pre-processor of the first camera system. If the prediction is that the object will enter the second field of view, tracking data are provided to the second camera system. The tracking data provided to the second camera system may include pan, tilt and/or zoom adjustment data, which may be provided to a PTZ adjustment mechanism of the second camera system, for example. Alternatively, or in addition, the tracking data provided to the second camera system may include pan/tilt motion vector data, zoom factor data and/or shrinkage/expansion data, which are provided to a motion tracking processor of the second camera system. Pan, tilt and/or zoom adjustment data may also be provided to a PTZ adjustment mechanism of the first camera system irrespective of the prediction of whether the object will enter the second field of view.

Because the preferred embodiments used a closed loop system, tracking the object is made easier and does not require a skilled operator even as the object moves between areas being monitored by different cameras. The tracking data, including handoff information between cameras, are generated by the system responding to the behavior of motion vector fields created by the object being tracked. This is in stark contrast with prior art open loop systems that require the operator to manually generate PTZ adjustment data by manipulating an input device separately for each camera.

2. Single Camera Embodiment

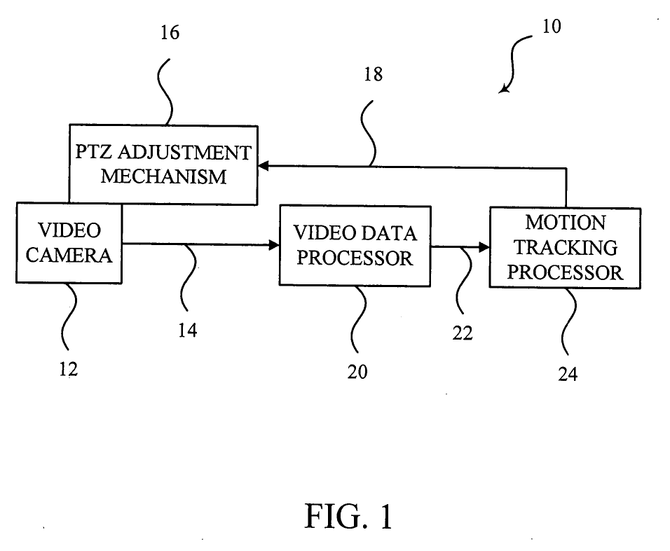

The advantages of the preferred embodiments are best understood by initially understanding a method, system and program product for a single camera to track an object using motion vector data. Referring to FIG. 1, a system 10 in accordance with the preferred embodiments includes a video camera 12 providing an output 14 that includes a sequence of video fields. As is conventional, video camera 12 includes a pan, tilt and/or zoom (PTZ) adjustment mechanism 16 that changes the current field of view of video camera 12 within its overall field of view, which typically corresponds with an area to be monitored. The PTZ adjustment mechanism 16 changes the pan, tilt and/or zoom of video camera 12 based on pan, tilt and/or zoom adjustment data 18 it receives. Beyond any movement provided by PTZ adjustment mechanism 16, video camera 12 may be fixed or mobile. The video camera 12 may take video images in the visual range or outside the visual range, e.g., infrared. The output 14 of video camera 12 may include audio in addition to video.

A video data processor 20 receives the output 14 of video camera 12 and provides digital video data including motion vector data 22 for an object in the field of view based on the sequence of video fields provided by video camera 12. The output 14 of video camera 12 may be provided to video data processor 20 via any type of connection, including wireless. Video data processor 20 may be separate from video camera 12 as shown in FIG. 1 or may be integrated with video camera 12. The video data processor 20 may include any digital signal processor, encoder or other image processing device that generates motion vectors, i.e., horizontal and vertical characteristics regarding an object being monitored. For example, video data processor 20 may include an MPEG (Moving Picture Experts Group) compression processor that provides motion vector data 22 at a macroblock level to the motion tracking processor. Alternatively, video data processor 20 may include a pre-processor that provides the motion vector data 22 at a pixel level to the motion tracking processor. Both pre-processors and MPEG compression processors are conventional and commercially available. On one hand, using an MPEG compression processor to provide motion vector data 22 is typically preferable from a cost perspective because MPEG compression processors are more widely used. On the other hand, using a pre-processor to provide motion vector data 22 may be preferable from a performance perspective.

The MPEG standard is a well known video compression standard. Within the MPEG standard, video compression is defined both within a given frame (also referred to herein as a “field”) and between frames. Video compression within a frame, i.e., spatial compression, is accomplished via a process of discrete cosine transformation, quantization, and run length encoding. Video compression between frames, i.e., temporal compression, is accomplished via a process referred to as motion estimation, in which a motion vector is used to describe the translation of a set of picture elements (pels) from one frame to another. These motion vectors track the movement of like pixels from frame to frame typically at a macroblock level. A macroblock is composed of 16×16 pixels or 8×8 pixels. The movement is broken down into mathematical vectors which identify the direction and distance traveled between video frames. These motion vectors are themselves typically encoded. A pre-processor is typically necessary to provide motion vector data at a sub-macroblock level, e.g., at a pixel level.

A motion tracking processor 24 receives motion vector data 22 from video data processor 20. In addition, motion tracking processor 24 may receive other digital video data from video data processor 20. The motion vector data 22 (and any other digital video data) from video data processor 20 may be provided to motion tracking processor 24 via any type of connection, including wireless. The motion tracking processor 24 may be separate from video data processor 20 as shown in FIG. 1 or may be integrated with video data processor 20. As described in detail below, motion tracking processor 24 calculates pan, tilt and/or zoom adjustment data 18 for the camera to track the object based on motion vector data 22 provided by the video data processor 20. The pan, tilt and/or zoom adjustment data 18 from motion tracking processor 24 may be provided to PTZ adjustment mechanism 16 of video camera 16 via any type of connection, including wireless.

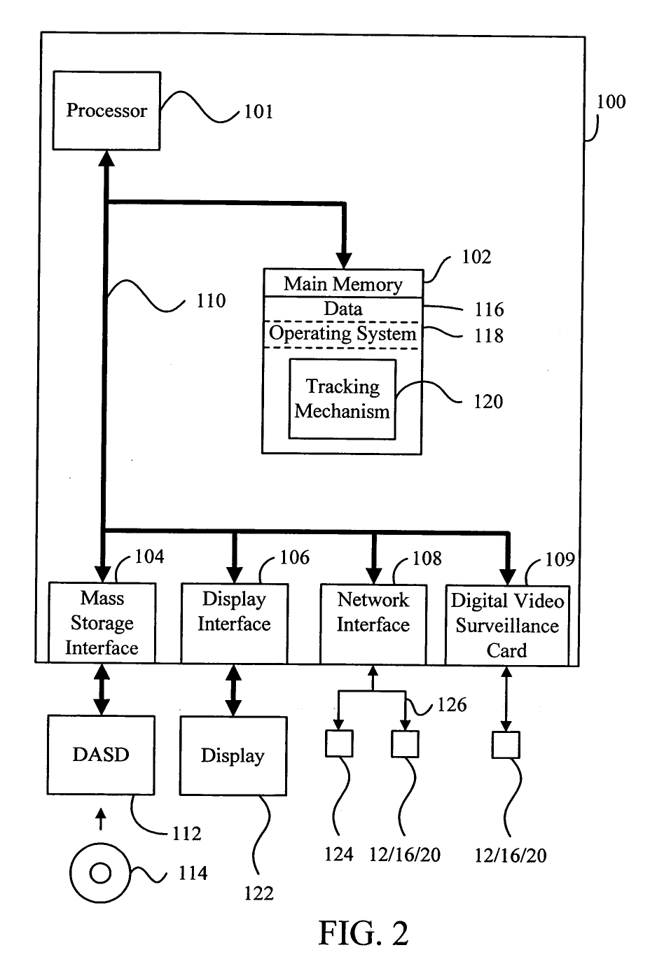

The motion tracking processor 24 will now be described with reference to FIG. 2 in the context of a particular computer system 100, i.e., an IBM iSeries computer system. However, those skilled in the art will appreciate that the method, system and program product of the present invention apply equally to any computer system, regardless of whether the computer system is a complicated multi-user computing apparatus, a single user workstation, or an embedded control system. The computer system 100 is preferably present in one or more monitoring stations, which may be fixed and/or mobile. As shown in FIG. 2, computer system 100 comprises a processor 101, a main memory 102, a mass storage interface 104, a display interface 106, and a network interface 108. Optionally, computer system 100 further comprises a digital video surveillance card 109. These system components are interconnected through the use of a system bus 110. Mass storage interface 104 is used to connect mass storage devices (such as a direct access storage device 112) to computer system 100. One specific type of direct access storage device 112 is a readable and writable CD ROM drive, which may store data to and read data from a CD ROM 114.

Note that system processor 101 shown in FIG. 2 may correspond to motion tracking processor 24 discussed above with reference to FIG. 1. It should be noted, however, the motion tracking processor 24 may also correspond, partially or completely, to another processor associated with computer system 100, such as a microprocessor on digital video surveillance card 109. The use of such a microprocessor may be desirable to off-load compute-intensive processing from system processor 101.

Main memory 102 in accordance with the preferred embodiments contains data 116, an operating system 118, and a tracking mechanism 120 that will be described in detail below. While the tracking mechanism 120 is shown separate and discrete from operating system 118 in FIG. 2, the preferred embodiments expressly extend to tracking mechanism 120 being implemented within the operating system 118. In addition, tracking mechanism 120 could be implemented in application software, utilities, or other types of software within the scope of the preferred embodiments.

Computer system 100 utilizes well known virtual addressing mechanisms that allow the programs of computer system 100 to behave as if they have access to a large, single storage entity instead of access to multiple, smaller storage entities such as main memory 102 and DASD device 112. Therefore, while data 116, operating system 118, and tracking mechanism 120 are shown to reside in main memory 102, those skilled in the art will recognize that these items are not necessarily all completely contained in main memory 102 at the same time. It should also be noted that the term “memory” is used herein to generically refer to the entire virtual memory of the computer system 100, including a memory on digital video surveillance card 109.

Data 116 represents any data that serves as input to or output from any program in computer system 100. Operating system 118 is a multitasking operating system known in the industry as OS/400; however, those skilled in the art will appreciate that the spirit and scope of the present invention is not limited to any one operating system.

Processor 101 may be constructed from one or more microprocessors and/or integrated circuits. Processor 101 executes program instructions stored in main memory 102. In addition, if motion tracking processor 24 (shown in FIG. 1) is resident on digital video surveillance card 109 or elsewhere in computer system 100, motion tracking processor 24 may execute program instructions stored in main memory 102. Main memory 102 stores programs and data that may be accessed by processor 101, as well as by motion tracking processor 24 if present on digital video surveillance card 109 or elsewhere in computer system 100. When computer system 100 starts up, processor 101 initially executes the program instructions that make up operating system 118. Operating system 118 is a sophisticated program that manages the resources of computer system 100. Some of these resources are processor 101, main memory 102, mass storage interface 104, display interface 106, network interface 108, digital surveillance card 109 and system bus 110.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 101. However, those skilled in the art will appreciate that the present invention applies equally to computer systems that simply use I/O adapters to perform similar functions.

Display interface 106 is used to directly connect one or more displays 122 to computer system 100. These displays 122, which may be non-intelligent (i.e., dumb) terminals or fully programmable workstations, are used to allow system administrators and users (also referred to herein as “operators”) to communicate with computer system 100. Note, however, that while display interface 106 is provided to support communication with one or more displays 122, computer system 100 does not necessarily require a display 122, because all needed interaction with users and processes may occur via network interface 108.

Network interface 108 is used to connect other computer systems and/or workstations (e.g., 124 in FIG. 2) to computer system 100 across a network 126. In addition, network interface 108 may be used to connect PTZ adjustment mechanism 16 and/or video data processor 20 to computer system 100 across network 126. Likewise, if video data processor 20 is resident on digital video surveillance card 109 or elsewhere in computer system 100, network interface 108 may be used to connect video camera 12 to computer system 100. The present invention applies equally no matter how computer system 100 may be connected to other computer systems and/or workstations, video camera 12, PTZ adjustment mechanism 16, and/or video data processor 20, regardless of whether the network connection 126 is made using present-day analog and/or digital techniques or via some networking mechanism of the future. In addition, many different network protocols can be used to implement a network. These protocols are specialized computer programs that allow computers to communicate across network 126. TCP/IP (Transmission Control Protocol/Internet Protocol) is an example of a suitable network protocol.

Alternatively, an I/O adapter may be used to connect PTZ adjustment mechanism 16 and/or video data processor 20 to computer system 100. In addition, if video data processor 20 is resident on digital video surveillance card 109 or elsewhere in computer system 100, an I/O adapter may also be used to connect video camera 12 to computer system 100. For example, video camera 12, PTZ adjustment mechanism 16 and/or video data processor 20 may be connected to computer system 100 using an I/O adapter on digital video surveillance card 109. In a variation of this alternative, a system I/O adapter may be used to connect video camera 12, PTZ adjustment mechanism 16 and/or video data processor 20 to computer system 100 through system bus 110.

At this point, it is important to note that while the present invention has been and will be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g., 114 of FIG. 2), and transmission type media such as digital and analog communications links.

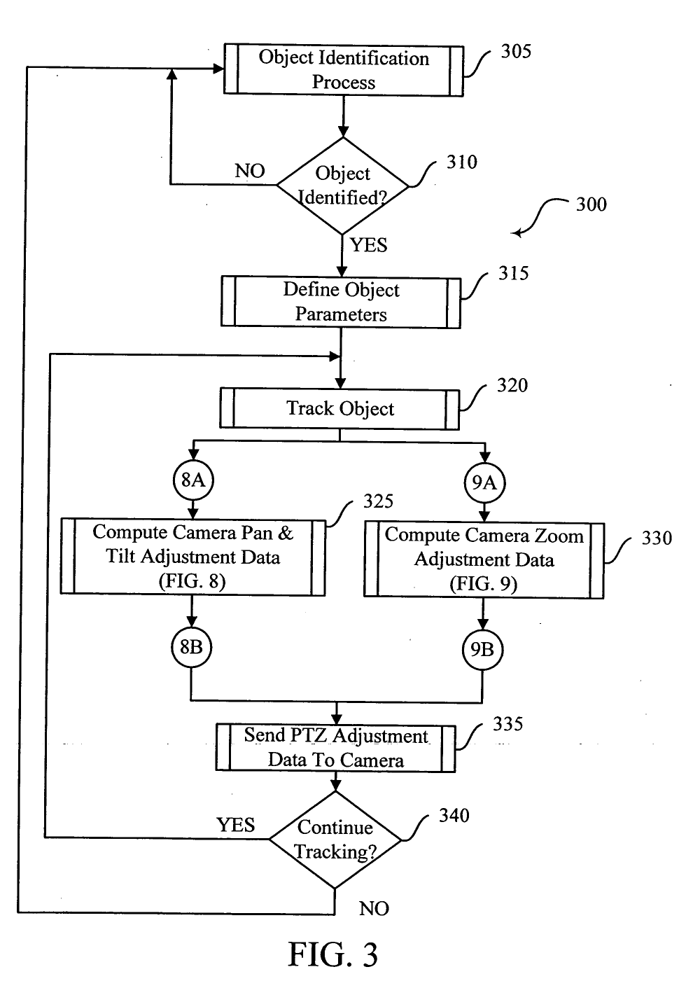

Referring to FIG. 3, a method 300 in accordance with the preferred embodiments allows a video camera to track an object using motion vector data. Initially, an object identification process is performed (step 305). Any conventional object identification process may be utilized in step 305. For example, conventional motion detection processors typically perform object identification. Next, method 300 determines whether an object was identified (step 310). If an object was not identified (step 310=NO), method 300 loops back to step 305. On the other hand, if an object was detected (step 310=YES), method 300 continues by defining object parameters (step 315). Step 315 is conventional, but is briefly described in the discussion that follows. The object parameters defined in step 315 include object boundary, object size and object center point, as well as camera initial focal length. The object parameters may be based on either individual pixels or groups of pixels, such as an MPEG macroblock. The object center point may be a centroid or the center of an area of highest interest, such as the center of a face when tracking a person. The method 300 continues by tracking the object based on location and motion vectors (step 320). Steps 305, 310, 315 and 320 may be executed by video data processor 20 (shown in FIG. 1) and/or motion tracking processor 24 (shown in FIG. 1). If one or more of these steps is executed by video data processor 20, video data generated by video data processor 20 in the execution of each such step are provided to motion tracking processor 24. On the other hand, if one or more of these steps is executed by motion tracking processor 24, video data processor 20 provides any video data to motion tracking processor 24 necessary for execution of each such step.

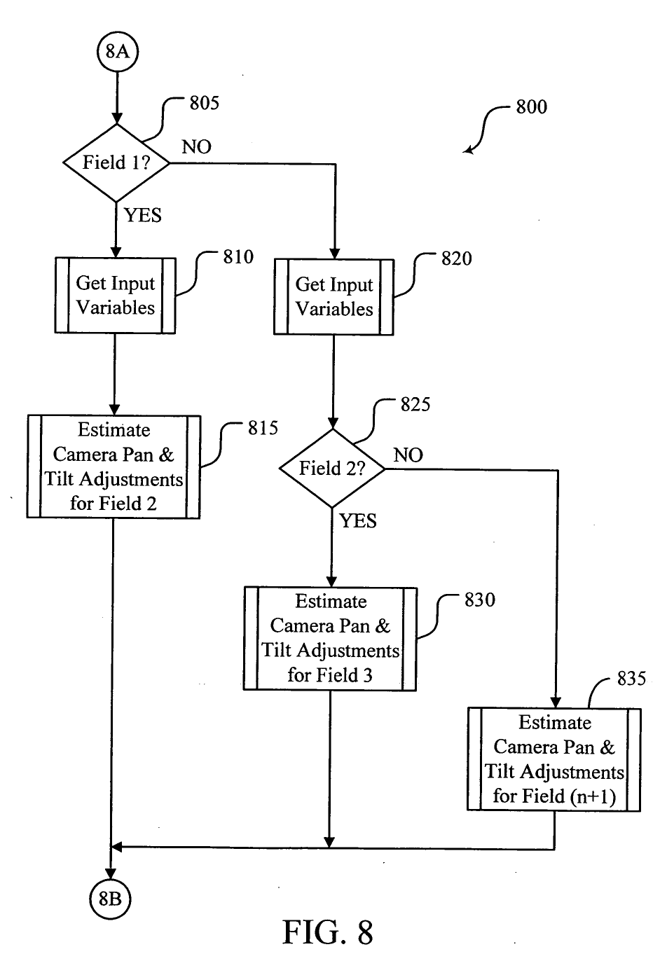

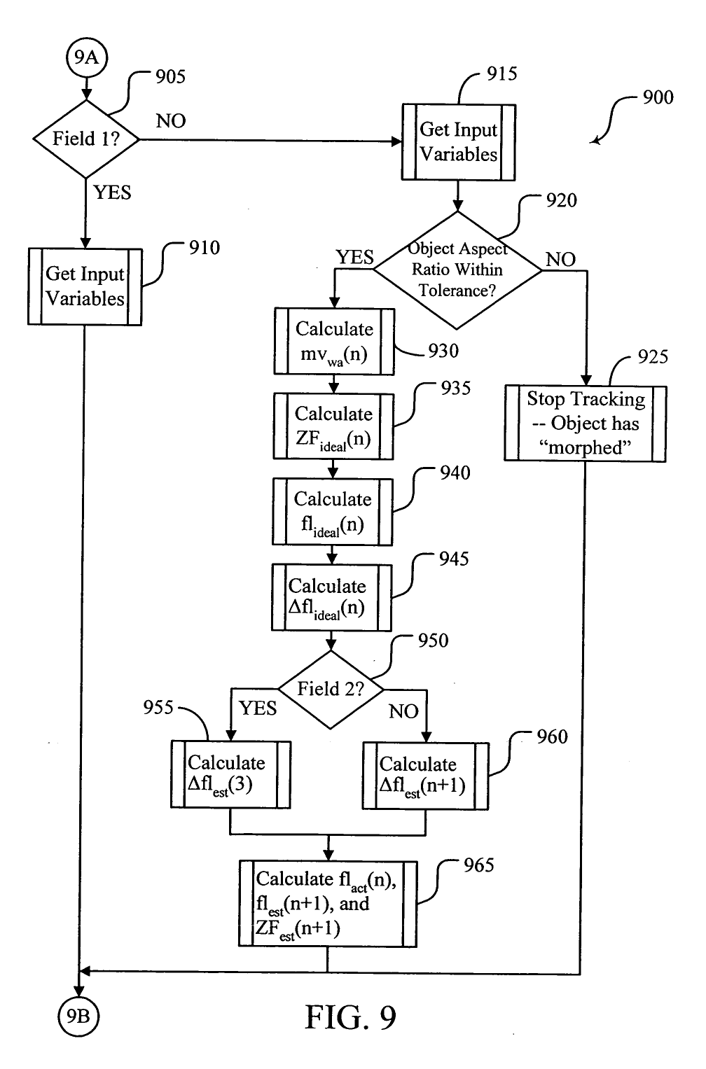

Method 300 continues by computing camera pan and tilt adjustment data (step 325) and computing camera zoom adjustment data (step 330). Steps 325 and 330 are more described in detail below with reference to FIGS. 8 and 9, respectively. In the preferred embodiments, all adjustments assume constant velocity or acceleration of the object to determine the next camera location. However, those skilled in the art will appreciate that the present invention applies equally to adjustments made without these assumptions. As discussed in more detail below, the pan and tilt adjustment data are calculated relative to the object center point and the center point of the camera field of view. Also as discussed in more detail below, the zoom adjustment data are based on net contraction or expansion of the object boundary. Preferably, steps 325 and 330 are executed concurrently (in a multitasking fashion) as shown in FIG. 3. However, those skilled in the art will appreciate that the present invention may be practiced by executing steps 325 and 330 sequentially or as a combined single step. In addition, those skilled in the art will appreciate that the present invention may be practiced by omitting one of steps 325 and 330. Those skilled in the art will also appreciate that the present invention may be practiced by calculating any combination of pan, tilt and/or zoom adjustment data. Steps 325 and 330 are executed by motion tracking processor 24 (shown in FIG. 1). Video data processor 20 (shown in FIG. 1) provides video data to motion tracking processor 24 necessary for execution of these steps.

Having calculated the pan, tilt and/or zoom adjustment data, method 300 proceeds (step 335) to send the pan, tilt and/or adjustment data to PTZ adjustment mechanism 16 (shown in FIG. 1) of video camera 12 (shown in FIG. 1). Step 335 is executed by motion tracking processor 24 (shown in FIG. 1). The tracking mechanism 120 (shown in FIG. 2) includes program instructions that at least correspond to steps 325, 330 and 335. [0044] Next, method 300 determines whether tracking is to continue (step 340). If tracking is to continue (step 340=YES), method 300 loops back to step 320. On the other hand, if tracking is not to continue (step 340=NO), method 300 loops back to step 305. Step 340 may be executed by video data processor 20 and/or motion tracking processor 24. If this step is executed by video data processor 20, video data generated by video data processor 20 in the execution of the step are provided to motion tracking processor 24. On the other hand, if this step is executed by motion tracking processor 24, video data processor 20 provides any video data to motion tracking processor 24 necessary for execution of the step.

Steps 325 and 330 are best understood by initially describing the camera field of view and the camera field of view progression, as well as defining variables and formulas used in the calculation of the pan, tilt and/or adjustment data.

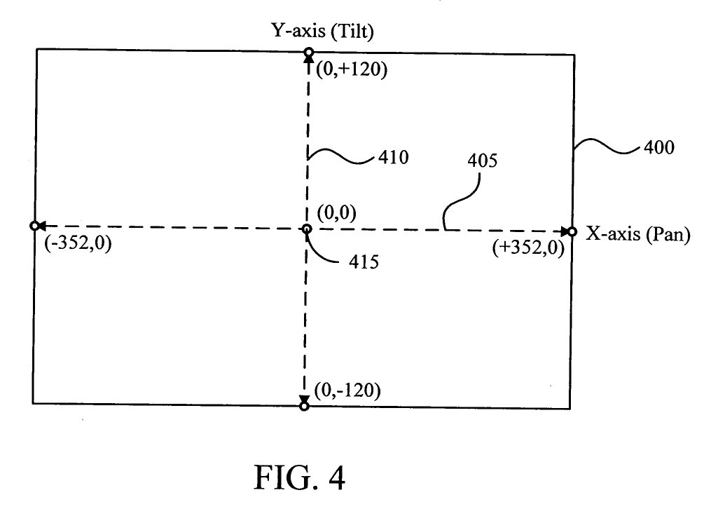

FIG. 4 shows a camera field of view 400 in accordance with the preferred embodiments. The camera field of view is also referred to herein as a “field”. As shown in FIG. 4, camera field of view 400 has a horizontal X-axis 405 that extends 704 pixels (x=−352 to x=+352) and a vertical Y-axis 410 that extends 240 pixels (y=−120 to y=+120). The horizontal X-axis 405 is the direction along which PTZ adjustment mechanism 16 (shown in FIG. 1) pans video camera 12 (shown in FIG. 1). Similarly, the vertical Y-axis 410 is the direction along which PTZ adjustment mechanism 16 (shown in FIG. 1) tilts video camera 12 (shown in FIG. 1). The center point 415 of the camera field of view 400 is located at coordinate (x=0, y=0). The camera field of view shown in FIG. 4 is exemplary. Those skilled in the art will appreciate that the present invention may be practiced by other field of view configurations.

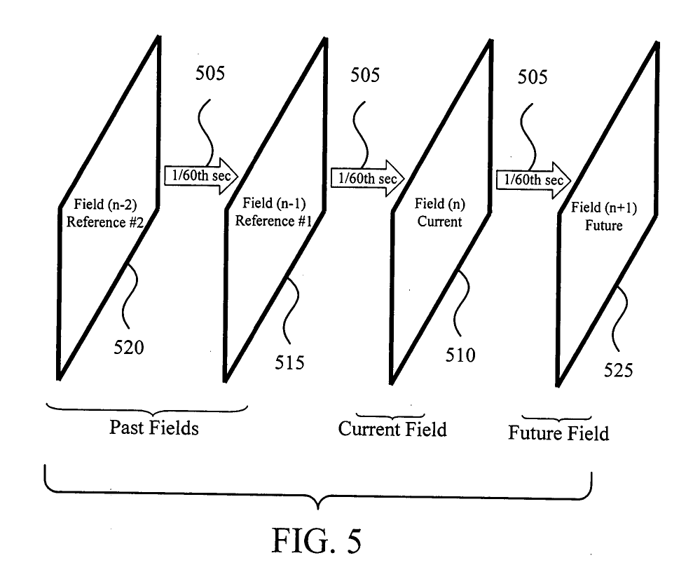

FIG. 5 shows a camera field progression 500. The time interval 505 between each field of view is 1/60^{th} second, which is the inter-field time for NTSC. The time interval shown in FIG. 5 is exemplary. Those skilled in the art will appreciate that the present invention may be practiced using other time intervals. FIG. 5 shows a current field 510, a past field (reference #1) 515, a past field (reference #2) 520 and a future field 525. The current field 510 is also referred to herein using the equation nomenclature field (n). The past field 515 (reference #1) is also referred to herein using the equation nomenclature field (n−1). The past field 520 (reference #2) is also referred to herein using the equation nomenclature field (n−2). The future field 525 is referred to herein using the equation nomenclature field (n+1).

Variables and formulas used in the calculation of the pan, tilt and/or zoom adjustment data in accordance with the preferred embodiments are described below. Initially, variables and formulas used in the calculation of pan and tilt adjustment data are described. Thereafter, variables and formulas used in the calculation of zoom adjustment data are described.

The following variables are used in the calculation of pan and tilt adjustment data.
mv_{camera}(n+1)≡predicted camera pan and tilt adjustments between current field (n) and future field (n+1) expressed as pixel pair (pan_distance,tilt_distance).
loc_{oc}(n)≡object center location in current field (n) expressed as pixel pair (oc_x,oc_y).
mv_{oc-rel}[(n−1) [symbol] (n)]≡relative object center motion vector from reference #1 field (n−1) to current field (n) expressed as pixel pair (Δoc_rel_x,Δoc_rel_y).
mv_{oc-accel}[(n−2) [symbol] (n)]≡relative object center acceleration vector from reference #2 field (n−2) to current field (n) expressed as pixel pair (Δ[Δoc_rel_x]Δ[Δoc_rel_y]).
mv_{oc}(n)≡object center motion vector from reference #1 field (n−1) to current field (n) expressed as pixel pair (Δoc_x,Δoc_y).

Formulas used in the calculation of pan and tilt adjustment data according to the preferred embodiments are now described below. In accordance with the preferred embodiments, the formulas used in the calculation of pan and tilt adjustment data vary depending on the number of field(s) of data available. When three fields of data are available (i.e., current field (n), reference #1 field (n−1), and reference #2 field (n−2)), the object trajectory is fully characterized. In this case, the camera pan and tilt calculations assume the object travels at constant velocity or acceleration.
mv_{camera}(n+1)=loc_{oc}(n)+mv_{oc-rel}[(n−1) [symbol] (n)]+mv_{oc-accel}[(n−2) [symbol] (n)];
mv_{oc-rel}[(n−1) [symbol] (n)]=loc_{oc}(n)−loc_{oc}(n−1)+mv_{camera}(n);
mv_{oc-accel}[(n−2) [symbol] (n)]=mv_{oc-rel}[(n−1) [symbol] (n)]−mv_{oc-rel}[(n−2) [symbol] (n−1)];
=[loc_{oc}(n)−loc_{oc}(n−1)+mv_{camera}(n)]−[loc_{oc}(n−1)−loc_{oc}(n−2)+mv_{camera}(n−1)];
mv_{camera}(n+1)=loc_{oc}(n)+[loc_{oc}(n)−loc_{oc}(n−1)+mv_{camera}(n)]+{[loc_{oc}(n)−loc_{oc}(n−1)+mv_{camera}(n)]−[loc_{oc}(n−1)−loc_{oc}(n−2)+mv_{camera}(n−1)]};
=3×[loc_{oc}(n)−loc_{oc}(n−1)]loc_{oc}(n−2)+[2×mv_{camera}(n)]−mv_{camera}(n−1);
mv_{oc}(n)=loc_{oc}(n)−loc_{oc}(n−1);
mv_{camera}(n+1)=[3×mv_{oc}(n)]loc_{oc}(n−2)+[2×mv×camera(n)]−mv_{camera}(n−1).

When two fields of data are available (i.e., current field (n), and reference #1 field (n−1)), the object trajectory is partially characterized. In this case, the camera pan and tilt calculations assume the object travels at constant velocity and follows a linear path.
mv_{camera}(n+1)=loc_{oc}(n)+mv_{oc-rel}[(n−1) [symbol] (n)];
mv_{oc-rel}[(n−1) [symbol] (n)]=loc_{oc}(n)−loc_{oc}(n−1)+mv_{camera}(n);
mv_{camera}(n+1)=loc_{oc}(n)+[loc_{oc}(n)−loc_{oc}(n−1)+mv_{camera}(n)];
mv_{oc}(n)=loc_{oc}(n)−loc_{oc}(n−1);
mv_{camera}(n+1)=[2×mv_{oc}(n)]+loc_{oc}(n−1)+mv_{camera}(n).

When one field of data is available (i.e., current field (n)), the object trajectory is unknown. In this case, the camera pan and tilt calculations reposition the video camera along a linear trajectory defined by the current object center location and current field origin.
mv_{camera}(n+1)=ISF×loc_{oc}(n);
ISF=user-specified initial scaling factor=½ (default value).

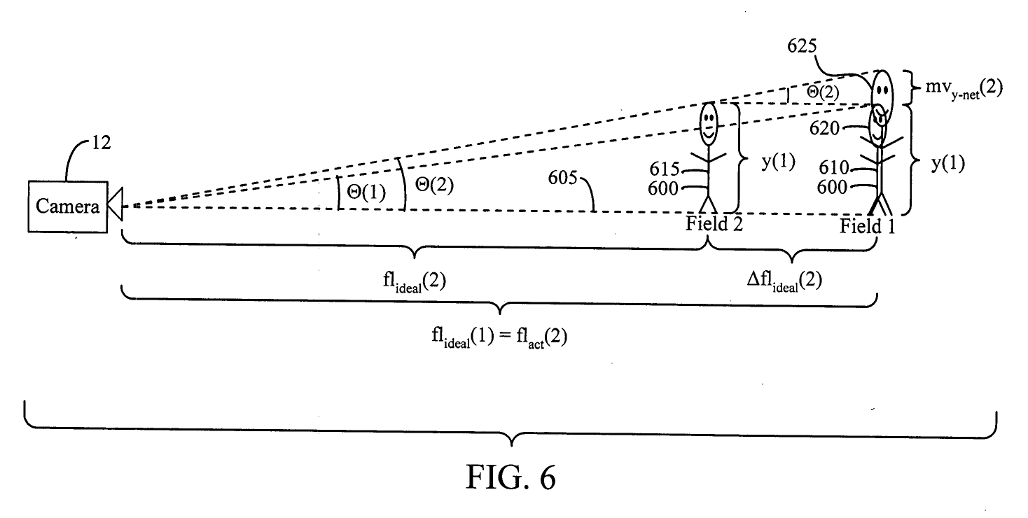

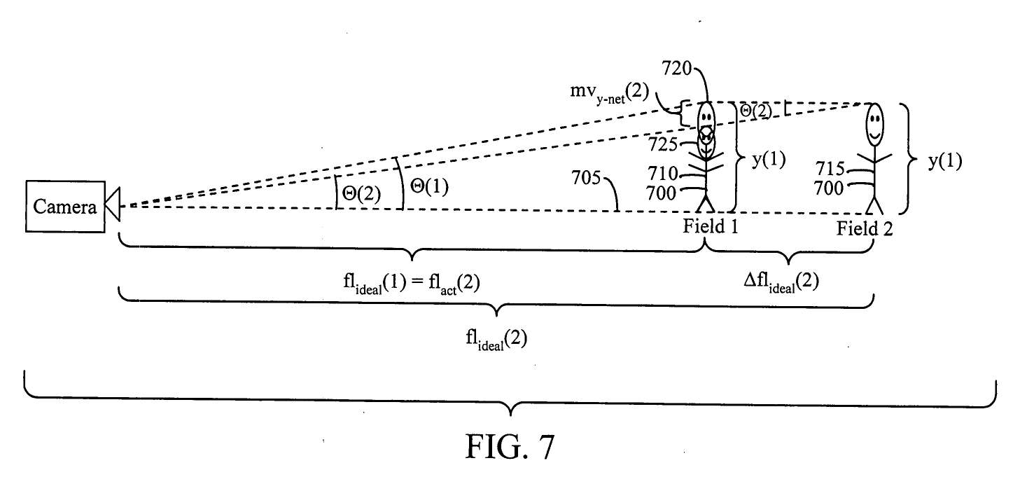

Now referring to FIGS. 6 and 7, the following variables are used in the calculation of zoom adjustment data according to the preferred embodiments. FIGS. 6 and 7 show a camera zoom adjustment model according to the preferred embodiments. For the sake of simplicity, only object boundary changes in height (y_dimension) are shown in FIGS. 6 and 7. Object boundary changes in width (x_dimension) would extend perpendicular to the plane of FIGS. 6 and 7. Also for the sake of simplicity, only object boundary changes from field 1 to field 2 are shown in FIGS. 6 and 7. Variables used in the calculation of zoom adjustment data beyond the object boundary changes shown in FIGS. 6 and 7, e.g., from field 2 to field 3 and from field (n) to field (n+1), are included for reference in the discussion below. EI=External Input to algorithm; CV=Calculated Value by algorithm.
y(1)≡field 1 object height in pixels at ideal focal length for optimal viewing. (EI)
y(n)≡field (n) object height in pixels at ideal focal length for optimal viewing. (CV)
x(1)≡field 1 object width in pixels at ideal focal length for optimal viewing. (EI)
x(n)≡field (n) object width in pixels at ideal focal length for optimal viewing. (CV)
f1_{ideal}(1)≡field 1 ideal focal length for optimal viewing of moving object. (EI)
f1_{ideal}(2)≡field 2 ideal focal length for optimal viewing of moving object. (CV)
f1_{ideal}(n)≡field (n) ideal focal length for optimal viewing of moving object. (CV)
f1_{act}(1)≡field 1 actual focal length. (CV)
f1_{act}(n)≡field (n) actual focal length. (CV)
Δf1_{ideal}(1)≡field 1 initial ideal focal length change. (CV)
Δf1_{ideal}(2)≡change in ideal focal length from field 1 to field 2. (CV)
Δf1_{ideal}(n)≡change in ideal focal length from field (n−1) to field (n). (CV)
f1ₑₛₜ(n+1) field (n+1) estimated focal length. (CV)
Δf1ₑₛₜ(3)≡estimated field 3 focal length change. (CV)
Δf1ₑₛₜ(n+1)≡estimated field (n+1) focal length change. (CV)
mv_{y-net}(1)≡field 1 net object height change. (CV)
mv_{y-net}(n)≡net object height expansion or contraction from field 1 to field (n). (CV)
mvₓ₋ₙₑₜ(1)≡field 1 net object width change. (CV)
mvₓ₋ₙₑₜ(n)≡net object width expansion or contraction from field 1 to field (n). (CV)
mv_{y-net}[(n−1) [symbol] (n)]≡net object height expansion or contraction from field (n−1) to field (n). (EI)
mvₓ₋ₙₑₜ[(n−1) [symbol] (n)]≡net object width expansion or contraction from field (n−1) to field (n). (EI)
mv_{wa}(n)≡weighted net object expansion or contraction in field (n). (CV)
Θ(1)≡field 1 focal angle. (Used to derive equations.)
Θ(2)≡field 2 focal angle. (Used to derive equations.)
ΔAR≡permitted deviation of object aspect ratio from initial value. (EI)
os_{wa}≡weighted average object size. (CV)
ZFₑₛₜ(2)≡field 2 estimated zoom factor. (CV)
ZFₑₛₜ(n+1)≡field (n+1) estimated zoom factor. (CV)
ZF_{ideal}(n)≡ideal zoom factor for field (n) based on actual object expansion or contraction from field (n−1) to field (n). (CV)

As mentioned above, FIGS. 6 and 7 show a camera zoom adjustment model according to the preferred embodiments. More specifically, FIG. 6 shows the case of zoom out camera adjustment. On the other hand, FIG. 7 shows the case of zoom in camera adjustment. FIGS. 6 and 7 show a person as the object. However, those skilled in the art will appreciate that the present invention is applicable to other objects. In addition, FIGS. 6 and 7 also show the outline of the person as the object boundary. However, those skilled in the art will appreciate that the present invention is applicable to other boundaries, such as an eye of the person. Also, the object is assumed to have a constant physical boundary size in this model. However, those skilled in the art will appreciate that the present invention applies equally to zoom adjustments made without this assumption.

Referring now to FIG. 6, the motion of an object 600 from field 1 to field 2 is shown, i.e., object 600 is moving from right to left (as shown in FIG. 6) along an axis 605 toward camera 12. More specifically, FIG. 6 shows an actual field 1 location 610, an actual field 2 location 615, an actual field 1 object image 620 captured by camera 12, and an actual field 2 object image 625 captured by camera 12 assuming no camera zoom adjustment. As shown in FIG. 6, mv_{y-net}(2) is greater than zero, which corresponds to a net object height increase. In this case, camera 12 must zoom out to maintain the image size from field 1 to field 2. For zoom out, the ideal zoom factor ZF_{ideal}(2) from field 1 to field 2 for optimal object viewing is derived as follows.
f1_{ideal}(2)=f1_{ideal}(1)−Δf1_{ideal}(2);
tan[Θ(2)]=[y(1)+mv_{y-net}(2)]/f1_{ideal}(1)=mv_{y-net}(2)/Δf1_{ideal}(2);
Δf1_{ideal}(2)=f1_{ideal}(1)×{mv_{y-net}(2)/[y(1)+mv_{y-net}(2)];

$$\begin{matrix}{f1}_{ideal} ( 2 ) = {f1}_{ideal} ( 1 ) ⨯ ( 1 - \{ {mv}_{y - net} ( 2 ) / [ y ( 1 ) + {mv}_{y - net} ( 2 ) ] \} ) ; \\ = {f1}_{ideal} ( 1 ) ⨯ \{ y ( 1 ) / [ y ( 1 ) + {mv}_{y - net} ( 2 ) ] \} ; \\ = {f1}_{ideal} ( 1 ) ⨯ {ZF}_{ideal} ( 2 ) ;\end{matrix}$$

ZF_{ideal}(2)=y(1)/[y(1)+mv_{y-net}(2)].

Referring now to FIG. 7, the motion of an object 700 from field 1 to field 2 is shown, i.e., object 700 is moving from left to right (as shown in FIG. 7) along an axis 705 away camera 12. More specifically, FIG. 7 shows an actual field 1 location 710, an actual field 2 location 715, an actual field 1 object image 720 captured by camera 12, and an actual field 2 object image 725 captured by camera 12 assuming no camera zoom adjustment. As shown in FIG. 7, mv_{y-net}(2) is less than zero, which corresponds to a net object height decrease. In this case, camera 12 must zoom in to maintain the image size from field 1 to field 2. For zoom in, the ideal zoom factor ZF_{ideal}(2) from field 1 to field 2 for optimal object viewing is derived as follows.
f1_{ideal}(2)=f1_{ideal}(1)+Δf1_{ideal}(2);
tan[Θ(2)]=[y(1)+mv_{y-net}(2)]/f1_{ideal}(1)=−mv_{y-net}(2)/Δf1_{ideal}(2);
Δf1_{ideal}(2)=f1_{ideal}(1)×{−mv_{y-net}(2)/[y(1)+mv_{y-net}(2)];

$$\begin{matrix}{f1}_{ideal} ( 2 ) = {f1}_{ideal} ( 1 ) ⨯ ( 1 - \{ {mv}_{y - net} ( 2 ) / [ y ( 1 ) + {mv}_{y - net} ( 2 ) ] \} ) ; \\ = {f1}_{ideal} ( 1 ) ⨯ \{ y ( 1 ) / [ y ( 1 ) + {mv}_{y - net} ( 2 ) ] \} ; \\ = {f1}_{ideal} ( 1 ) ⨯ {ZF}_{ideal} ( 2 ) ;\end{matrix}$$

ZF_{ideal}(2)=y(1)/[y(1)+mv_{y-net}(2)].

Additional formulas used in the calculation of zoom according to the preferred embodiments are described below.

In accordance with the preferred embodiments, formulas follow for calculating the weighted average object size os_{wa}, net change in object height from field 1 to field (n) mv_{y-net}(n), net change in object width from field 1 to field (n) mvₓ₋ₙₑₜ(n), field (n) object height in pixels y(n), and field (n) object width in pixels x(n).
os_{wa}=[y(1)²+x(1)²]/[y(1)+x(1)]
mv_{y-net}(n)=mv_{y-net}[(n−1) [symbol] n]+mv_{y-net}(n−1);
mvₓ₋ₙₑₜ(n)=mvₓ₋ₙₑₜ[(n−1) [symbol] n]+mvₓ₋ₙₑₜ(n−1);
y(n)=y(1)+mv_{y-net}(n);
x(n)=x(1)+mvₓ₋ₙₑₜ(n).

In accordance with the preferred embodiments, the formula used to determine whether the object ratio is within tolerance follows.
[(1+ΔAR)×{y(1)/x(1)}]≧[y(n)/x(n)]≧[(1−ΔAR)×{y(1)/x(1)}]

In accordance with the preferred embodiments, formulas follow for calculating the weighted net object expansion or contraction mv_{wa}(n) in field (n); ideal zoom factor ZF_{ideal}(n) for field (n) based on actual object expansion or contraction from field (n−1) to field (n); field (n) ideal focal length f1_{ideal}(n) for optimal viewing of moving object; and change in ideal focal length Δf1_{ideal}(n) from field (n−1) to field (n). The ideal zoom factor ZF_{ideal}(n) is calculated based on the estimated zoom factor ZFₑₛₜ(n) and a net object expansion or contraction factor. The net object expansion or contraction factor is essentially a correction factor based on os_{wa}, y(1), mv_{y-net}(n), x(1), and mvₓ₋ₙₑₜ(n).
mv_{wa}(n)=[y(1)×mv_{y-net}(n)]+[x(1)×mvₓ₋ₙₑₜ(n)]/[y(1)+x(1)];
ZF_{ideal}(n)=[ZFₑₛₜ(n)×os_{wa}]/[os_{wa}+mv_{wa}(n)];
f1_{ideal}(n)=f1_{act}(n−1)×ZF_{ideal}(n);
Δf1_{ideal}(n)=f1_{ideal}(n)−f1_{ideal}(n−1).

In accordance with the preferred embodiments, the formulas used in the calculation of Δf1ₑₛₜ vary depending on the number of field(s) of data available, similar to the calculation of pan and tilt adjustment data described above. When two fields of data are available (i.e., field 1 and field 2), estimated field 3 focal length change Δf1ₑₛₜ(3) is estimated based on object velocity as follows.
Δf1ₑₛₜ(3)=Δf1_{ideal-vel}[1 [symbol] 2];
=Δf1_{ideal}(2).

When three fields of data are available (i.e., field (n−2), field (n−1) and field (n)), estimated field (n+1) focal length change Δf1ₑₛₜ(n+1) is estimated based on object velocity and object acceleration as follows.

$$\begin{matrix}Δ {f1}_{est} ( n + 1 ) = Δ {f1}_{ideal - vel} [ ( n - 1 ) ( n ) ] + Δ {f1}_{ideal - accel} [ ( n - 2 ) ( n ) ] ; \\ = Δ {f1}_{ideal} ( n ) + [ Δ {f1}_{ideal} ( n ) - Δ {f1}_{ideal} ( n - 1 ) ] ; \\ = [ 2 ⨯ Δ {f1}_{ideal} ( n ) ] - Δ {f1}_{ideal} ( n - 1 ) .\end{matrix}$$

In accordance with the preferred embodiments, formulas follow for calculating the field (n) actual focal length f1_{act}(n), field (n+1) estimated focal length f1ₑₛₜ(n+1) and field (n+1) estimated zoom factor ZFₑₛₜ(n+1).
f1_{act}(n)=f1_{act}(n−1)×ZFₑₛₜ(n);
f1ₑₛₜ(n+1)=f1_{ideal}(n)+Δf1ₑₛₜ(n+1);
ZFₑₛₜ(n+1)=f1ₑₛₜ(n+1)/f1_{act}(n).

Referring now to FIG. 8, a method 800 of computing camera pan and tilt adjustment data (step 325 shown in FIG. 3) according to preferred embodiments is shown in detail. Initially, method 800 determines whether the current field (n) is field 1 (step 805). If the current field (n) is field 1 (step 805=YES), method 800 gets values for variables loc_{oc}(1) and ISF (step 810). These variables are provided internally by motion tracking processor 24 (shown in FIG. 1) or retrieved from video data processor 20 (shown in FIG. 1). The variable loc_{oc}(1) is stored for use in future calculations. The method 800 continues (at step 815) by calculating variable mv_{camera}(2)=ISF×loc_{oc}(1), which is the estimated pan and tilt adjustments for field 2. This variable is stored for use in future calculations and method 800 returns to method 300 (step 335 shown in FIG. 3). If the current field (n) is not field 1 (step 805=NO), method 800 (at step 820) gets values for variable mv_{oc}(n) and assigns variable loc_{oc}(n)=loc_{oc}(n−1)+mv_{oc}(n). The variable mv_{oc}(n) is provided internally by motion tracking processor 24 (shown in FIG. 1) or retrieved from video data processor 20 (shown in FIG. 1). The variable loc_{oc}(n) is stored for use in future calculations. The method 800 next determines whether the current field (n) is field 2 (step 825). If the current field (n) is field 2 (step 825=YES), method 800 continues (at step 830) by calculating variable mv_{camera}(3)=[2×mv_{oc}(2)]+loc_{oc}(1)+mv_{camera}(2), which is the estimated pan and tilt adjustments for field 3. This variable is stored for use in future calculations and the method 800 returns to method 300 (step 335 shown in FIG. 3). If the current field (n) is not field 2 (step 825=NO), method 800 continues (at step 835) by calculating variable mv_{camera}(n+1)=[3×mv_{oc}(n)]+loc_{oc}(n−2)+[2×mv_{camera}(n)]−mv_{camera}(n−1), which is the estimated pan and tilt adjustments for field (n+1). This variable is stored for use in future calculations and the method 800 returns to method 300 (step 335 shown in FIG. 3).

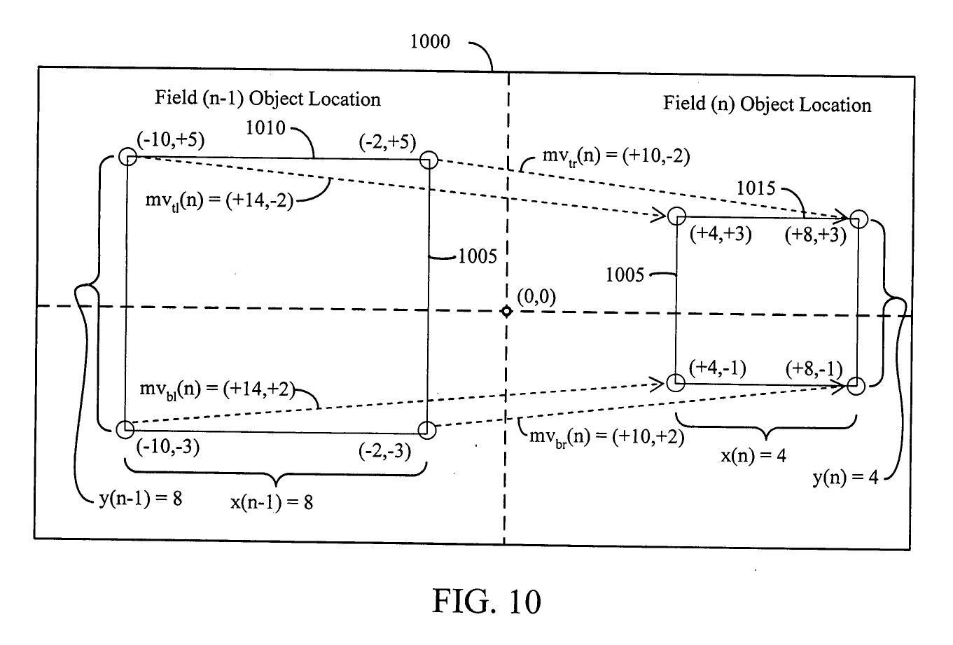

Referring now to FIG. 9, a method 900 of computing camera zoom adjustment data (step 330 shown in FIG. 3) according to preferred embodiments is shown in detail. Initially, method 900 determines whether the current field (n) is field 1 (step 905). If the current field (n) is field 1 (step 905=YES), method 900 (at step 910) gets values for variables f1_{ideal}(1); y(1); x(1); ΔAR; as well as assigning variables os_{wa}=[y(1)2+x(1)2]/[y(1)+x(1)]; mv_{y-net}(1)=0; mvₓ₋ₙₑₜ(1)=0; f1_{act}(1)=f1_{ideal}(1); Δf1_{ideal}(1)=0, and ZFₑₛₜ(2)=1 (no zoom) These variables are stored for use in future calculations and the method 900 returns to method 300 (step 335 shown in FIG. 3). The variables f1_{ideal}(1); y(1); x(1); and ΔAR are provided internally by motion tracking processor 24 (shown in FIG. 1) or retrieved from video data processor 20 (shown in FIG. 1). All these variables are stored for use in future calculations. If the current field (n) is not field 1 (step 905=NO), method 900 (at step 915) gets values for variables mv_{y-net}[(n−1) [symbol] (n)]; mvₓ₋ₙₑₜ[(n−1) [symbol] (n)]; as well as assigning variables mv_{y-net}(n)=mv_{y-net}[(n−1) [symbol] (n)]+mv_{y-net}(n−1); mvₓ₋ₙₑₜ(n)=mvₓ₋ₙₑₜ[(n−1) [symbol] n]+mvₓ₋ₙₑₜ(n−1); y(n)=y(1)+mv_{y-net}(n); and x(n)=x(1)+mv_{y-net}(n). The variables mv_{y-net}(n) and mvₓ₋ₙₑₜ(n) are stored for use in future calculations. The variables mv_{y-net}[(n−1) [symbol] (n)] and mvₓ₋ₙₑₜ[(n−1) [symbol] (n)] are provided internally by motion tracking processor 24 (shown in FIG. 1) or retrieved from video data processor 20 (shown in FIG. 1). Calculation of mv_{y-net}[(n−1) [symbol] (n)] and mvₓ₋ₙₑₜ[(n−1) [symbol] (n)] is discussed below with reference to FIG. 10. Next, method 900 determines (at step 920) whether the object aspect ratio is within tolerance by caclulating whether [(1+ΔAR)×{y(1)/x(1)}]≧[y(n)/x(n)]≧[(1−ΔAR)×{y(1)/x(1)}]. If the object aspect ratio is not within tolerance (step 920=NO), method 900 (at step 925) sets variable ZFₑₛₜ(n+1)=1, sets a stop tracking flag, and returns to method 300 (step 335 shown in FIG. 3). Tracking is stopped at step 925 because the object has “morphed”, i.e., the object has altered its shape. For example, the object may have rotated or “merged” with another object (e.g., a person being tracked may have moved behind a counter).

If the object aspect ratio is within tolerance (step 920=YES), method 900 calculates (at step 930) variable mv_{wa}(n)={[y(1)×mv_{y-net}(n)]+[x(1)×mvₓ₋ₙₑₜ(n)]}/[y(1)+x(1)]. Next, method 900 calculates (at step 935) variable ZF_{ideal}(n)=[ZFₑₛₜ(n)×os_{wa}]/[os_{wa}+mv_{wa}(n)]. The method 900 then calculates (at step 940) variable f1_{ideal}(n)=f1_{act}(n−1)×ZF_{ideal}(n). The variable f1_{ideal}(n) is stored for use in future calculations. Next, method 900 calculates (at step 945) variable Δf1_{ideal}(n)=f1_{ideal}(n)−f1_{ideal}(n−1). The variable Δf1_{ideal}(n) is stored for use in future calculations. The method 900 proceeds to determine whether the current field (n) is field 2 (step 950). If the current field (n) is field 2 (step 950=YES), method 900 calculates (at step 955) the variable Δf1ₑₛₜ(3)=Δf1_{ideal}(2). This estimate represents the constant velocity case assuming no additional object history data is available. In the event such additional object history data is available (for example, in the case where one camera hands off tracking data to a second camera), it is recognized that a focal length change estimate based on both object velocity and acceleration is possible as described in step 960. On the other hand, if the current field (n) is not field 2 (step 950=NO), method 900 calculates (at step 960) the variable Δf1ₑₛₜ(n+1)=[2×Δf1_{ideal}(n)]−Δf1_{ideal}(n−1). After either step 955 or step 960, the method 900 continues by calculating (at step 965) the variables f1_{act}(n)=f1_{act}(n−1)×ZFₑₛₜ(n); f1ₑₛₜ(n+1)=f1_{ideal}(n)+Δf1ₑₛₜ(n+1); and ZFₑₛₜ(n+1)=f1ₑₛₜ(n+1)/f1_{act}(n), which is the estimated zoom adjustment for field (n+1). The variables f1_{act}(n) and ZFₑₛₜ(n+1) are stored for use in future calculations and method 900 returns to method 300 (step 335 shown in FIG. 3).

As mentioned above, the variables mv_{y-net}[(n−1) [symbol] (n)] and mvₓ₋ₙₑₜ[(n−1) [symbol] (n)] are calculated internally by motion tracking processor 24 (shown in FIG. 1) or retrieved from video data processor 20 (shown in FIG. 1). In either case, calculation of mv_{y-net}[(n−1) [symbol] (n)] and mvₓ₋ₙₑₜ[(n−1) [symbol] (n)], which are also referred to herein as “shrinkage/expansion data”, is accomplished using the following equation.
{mvₓ₋ₙₑₜ[(n−1) [symbol] (n),mv_{y-net}[(n−1)]}={[ΣΔmvᵢ(x)/i,[ΣΔmvⱼ(y)/j}.
The symbol Σ denotes summation across all relevant expansion and compression reference vectors along the object boundary. It will be appreciated by one of skill in the art that the number of reference vectors in the x and y dimensions need not be the same. The symbol Δmvᵢ(x) denotes the difference in motion vector length between a pair of relevant reference points along the object boundary in the x dimension. On the other hand, the symbol Δmvⱼ(y) denotes the difference in motion vector length between a pair of relevant reference points along the object boundary in the y dimension. The symbols i and j denote the number of relevant reference point pairs along the object boundary in the x and y dimensions, respectively.

Referring now to FIG. 10, an example of net object contraction from field (n−1) to field (n) is shown to demonstrate calculation of mvₙₑₜ[(n−1) [symbol] (n)]. A camera field of view 1000 shows an object 1005 at a field (n−1) object location 1010 and at field (n) object location 1015. The hollow points at the corners of field (n−1) object location 1010 denote key expansion or contraction points along the boundary of object 1005. The coordinates of these points are (−10,+5), (−2,+5), (−10,−3), and (−2,−3). The hollow points at the corners of field (n) object location 1015 denote key expansion or contraction points along the boundary of object 1005. The coordinates of these points are (+4,+3), (+8,+3), (+4,−1), and (+8,−1). A motion vector mvₜ₁(n) extends from the top left corner of field (n−1) object location 1010 to the top left corner of field (n) object location 1015. The motion vector mvₜ₁(n) is {[+4−(−10)],[+3−(+5)]}=(+14,−2). A motion vector mvₜᵣ(n) extends from the top right corner of field (n−1) object location 1010 to the top right corner of field (n) object location 1015. The motion vector mvₜᵣ(n) is {[+8−(−2)],[+3−(+5)]}=(+10,−2). A motion vector mv_{b1}(n) extends from the bottom left corner of field (n−1) object location 1010 to the bottom left corner of field (n) object location 1015. The motion vector mv_{b1}(n) is {[+4−(−10)],[−1−(−3)]}(+14,+2). A motion vector mv_{br}(n) extends from the corner of field (n−1) object location 1010 to the bottom right corner of field (n) object location 1015. The motion vector mv_{br}(n) is {[+8−(−2)],[−1−(−3)]}=(+10,+2). The net object width and height expansion or contraction from field (n−1) to field (n), i.e., variables mv_{y-net}[(n−1) [symbol] (n)] and mvₓ₋ₙₑₜ[(n−1) [symbol] (n)], are calculated as follows.

$${mv}_{x - net} [ ( n - 1 ) ( n ) ] = [ {\sum }_{i = 1}^{2} Δ m {v}_{i} ( x ) ] / 2 ; = \{ [ {mv}_{x - tr} ( n ) - {mv}_{x - tl} ( n ) ] + [ {mv}_{x - br} ( n ) - {mv}_{x - bl} ( n ) ] \} / 2 ; = \{ [ 10 - 14 ] + [ 10 - 14 ] \} / 2 = - 8 / 2 = - 4.$$

$${mv}_{y - net} [ ( n - 1 ) ( n ) ] = [ {\sum }_{j = 1}^{2} Δ m {v}_{j} ( y ) ] / 2 ; = \{ [ {mv}_{y - tl} ( n ) - {mv}_{y - bl} ( n ) ] + [ {mv}_{y - tr} ( n ) - {mv}_{y - br} ( n ) ] \} / 2 ; = \{ [ - 2 - 2 ] + [ - 2 - 2 ] \} / 2 = - 8 / 2 = - 4.$$

The ability to continue tracking an object depends on the object maintaining it's aspect ratio within a certain user-specified tolerance. This tolerance (ΔAR) may be specified in a lookup table based on the type of object being tracked.

To account for the relative amount of expansion or contraction in both the x and y dimensions, os_{wa} and mv_{wa}(n) are defined. The variable os_{wa} represents the weighted average size of the object when viewed at the ideal focal length in field 1, where the object's width x(1) and height y(1) are weighted relative to the object's aspect ratio via multiplication by {x(1)/[x(1)+y(1)]} and {y(1)/[x(1)+y(1)]}, respectively. The variable mv_{wa}(n) represents the weighted average amount of object expansion or contraction in field (n), where the object net change in width mvₓ₋ₙₑₜ(n) and height mv_{y-net}(n) are weighted relative to the object's original aspect ratio via multiplication by {x(1)/[x(1)+y(1)]} and {y(1)/[x(1)+y(1)]}, respectively.

3. Multiple Camera Embodiment

A method, system and program product in accordance with the preferred embodiments use motion vector data to track an object moving between areas being monitored by a plurality of video cameras. According to the preferred embodiments, motion vector data are used to predict whether an object in a first field of view covered by a first video camera will enter a second field of view covered by a second video camera. The video cameras may be fixed and/or mobile. For example, video cameras may be fixedly mounted at several locations of an airport, e.g., along walkways, perimeter fences, runways, and gates. The images taken by the video cameras at the airport locations may be monitored at one or more monitoring stations, which may be fixed and/or mobile. A fixedly-mounted video camera may have the ability to pan, tilt, and/or zoom its current field of view within an overall field of view. Alternatively, video cameras may be mounted for mobility on one or more reconnaissance aircraft or other vehicle, with each such aircraft or other vehicle traveling to cover a reconnaissance area. The images taken by the video cameras within the reconnaissance areas may be monitored at one or more monitoring stations, which may be fixed and/or mobile. In addition to the mobility provided by the vehicle, a vehicle-mounted video camera may have the ability to pan, tilt, and zoom its current field of view within an overall field of view.

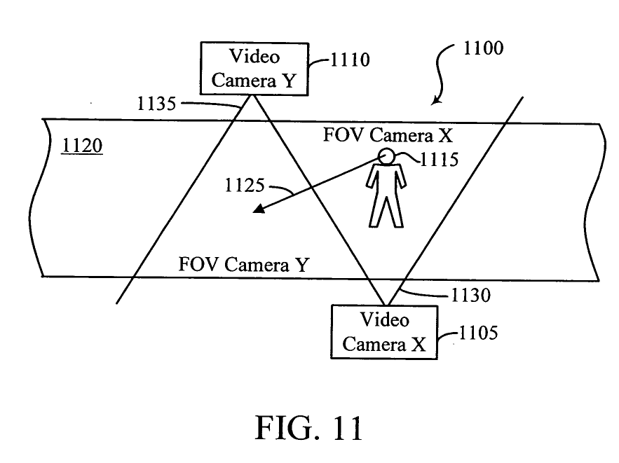

Referring now to FIG. 11, a schematic view of a multiple camera arrangement 1100 in accordance with the preferred embodiments is shown. For the sake of simplicity, only two video cameras 1105, 1110 are shown in FIG. 11. Those skilled in the art will appreciate, however, that the present invention may be practiced using any number of video cameras. Moreover, those skilled in the art will also appreciate that the present invention may be practiced using any desired arrangement of the video cameras. An object 1115 is shown on a walkway 1120, such as an airport concourse. Object 1115 is a person walking from right to left (as shown in FIG. 11) on walkway 1120. The motion of object 1115 is denoted by arrow 1125. Video camera 1105 has a field of view 1130, whereas video camera 1110 has a field of view 1135. According to the preferred embodiments, motion vector data are used to predict whether object 1115 in field of view 1130 covered by video camera 1105 will enter field of view 1135 covered by video camera 1110.

One or more of video cameras 1105, 1110 may correspond to video camera 12 (shown in FIG. 1) described above with respect to the single camera embodiment. In that case, which is described below, each such video camera would include a pan, tilt and/or zoom (PTZ) adjustment mechanism that changes the current field of view of the camera within its overall field of view. However, video cameras 1105 and 1110 need not include a PTZ adjustment mechanism. In this alternative case, the current field of view of each video camera would be identical to its overall field of view. In either case, the video cameras may be fixed and/or mobile. Likewise, the video cameras may take video images in the visual range and/or outside the visual range, e.g., infrared. Also, the output of one or more of the video cameras may include audio in addition to video.

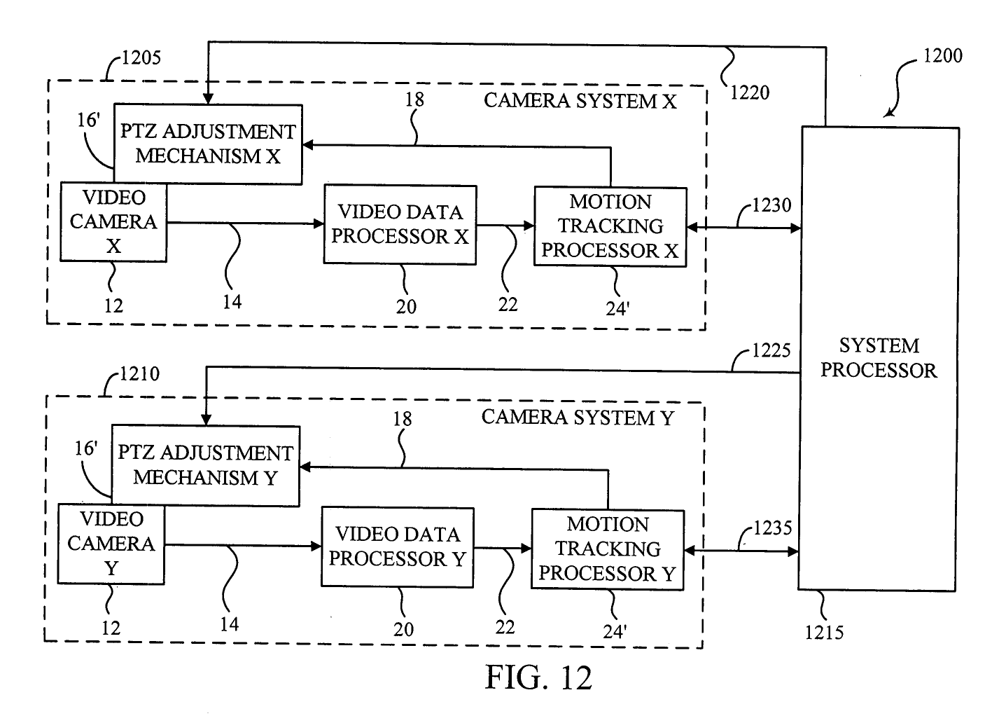

Referring to FIG. 12, a system 1200 in accordance with the preferred embodiments includes a plurality of video camera systems 1205, 1210 and a system processor 1215. For the sake of simplicity, only two video camera systems 1205, 1210 are shown in FIG. 12. Those skilled in the art will appreciate, however, that the present invention may be practiced using any number of video camera systems. Each video camera system 1205, 1210 essentially corresponds to the system 10 (shown in FIG. 1), with like designations denoting like elements. However, each video camera system 1205, 1210 includes a PTZ adjustment mechanism 16′ and a motion tracking processor 24′ that are modified relative to the single camera embodiment. The PTZ adjustment mechanisms 16′ are identical to PTZ adjustment mechanism 16 (shown in FIG. 1) except that each also changes the pan, tilt and/or zoom of its respective video camera 12 based on pan, tilt and/or zoom adjustment data 1220, 1225 it receives from system processor 1215. The pan, tilt and/or zoom adjustment data 1220, 1225 from system processor 1215 may be provided to PTZ adjustment mechanisms 16′ via any type of connection, including wireless.

The motion tracking processors 24′ are identical to motion tracking processor 24 (shown in FIG. 1) except that each also sends and receives tracking data 1230, 1235 to and from system processor 1215. The tracking data 1230, 1235 may include object motion vector data, object shrinkage/expansion data, and/or other digital video data. The tracking data 1230, 1235 may be transferred between motion tracking processors 24′ and system processor 1215 via any type of connection, including wireless. The motion tracking processors 24′ may be separate from each other and from system processor 1215 as shown in FIG. 1, or may be integrated with each other and/or system processor 1215.

Motion tracking processors 24′ and/or system processor 1215 predict whether an object will move from one video camera's field of view to the other camera's field of view based on motion vector data. If the object is predicted to enter the other camera's field of view, system processor 1215 provides tracking data to the other camera system's PTZ adjustment mechanism 16′ and/or motion tracking processor 24′. For example, system processor 1215 may calculate and provide pan, tilt and/or zoom adjustment data 1225 to PTZ adjustment mechanism 16′ of video camera system 1210 for camera 12 of video camera system 1210 to track the object as it moves between the fields of view based on tracking data 1230 provided to system processor 1215 by the motion tracking processor 24′ of video camera system 1205. Alternatively or in addition, system processor 1215 may provide tracking data 1235 to motion tracking processor 24′ of video camera system 1210 based on tracking data 1230 provided to system processor 1215 by the motion tracking processor 24′ of video camera system 1205. The tracking data 1230, 1235 may include at least one of object motion vector data, object shrinkage/expansion data, and other digital video data.

The PTZ adjustment data 1220, 1225 provided to PTZ adjustment mechanisms 16′ by system processor 1215 are calculated in the same manner as described above with respect to the single camera embodiment. The PTZ adjustment data 1220, 1225 provided to PTZ adjustment mechanisms 16′ by system processor 1215 may be calculated in system processor 1215. For example, PTZ adjustment data 1225 provided to PTZ adjustment mechanism 16′ of camera system 1210 by system processor 1215 may be calculated by system processor 1215 based on tracking data 1230 provided to system processor 1215 by motion tracking processor 24′ of camera system 1205 and tracking data 1235 provided to system processor 1215 by motion tracking processor 24′ of camera system 1210. In this example, the tracking data 1230 provided to system processor 1215 by motion tracking processor 24′ of camera system 1205 may include object motion vector data, object shrinkage/expansion data relative to an object in the field of view of camera system 1205. Also in this example, the tracking data 1235 provided to system processor 1215 by motion tracking processor 24′ of camera system 1210 may include input variables relating to camera system 1210.

Alternatively, the PTZ adjustment data 1220, 1225 provided to PTZ adjustment mechanism 16′ by system processor 1215 may be at least partially calculated in one camera system's motion tracking processor 24′ before being received as tracking data 1230, 1235 by system processor 1215 which in turn provides the PTZ adjustment data 1220, 1225 to the other camera system's PTZ adjustment mechanism 16′. In this alternative case, tracking data 1230, 1235 provided to one camera system's motion tracking processors 24′ by system processor 1215 may include input variables relating to the other camera system. For example, tracking data 1230 provided to motion tracking processor 24′ of camera system 1205 by system processor 1215 may include input variables relating to camera system 1210.

Similarly, tracking data 1230, 1235 provided to motion tracking processors 24′ by system processor 1215 may include many of the same variables described above with respect to the single camera embodiment. That is, the variables and equations described above with respect to the single camera embodiment are also used in the calculation of tracking data 1230, 1235 provided to motion tracking processors 24′ by system processor 1215. The tracking data 1230, 1235 provided to motion tracking processors 24′ by system processor 1215 may be calculated in system processor 1215. For example, tracking data 1235 provided to motion tracking processor 24′ of camera system 1210 by system processor 1215 may be calculated by system processor 1215 based on tracking data 1230 provided to system processor 1215 by motion tracking processor 24′ of camera system 1205. In this example, the tracking data 1235 provided to system processor 1215 by motion tracking processor 24′ of camera system 1210 may include field of view boundary data of camera system 1210 so that system processor 1215 may predict whether an object in the field of view of camera system 1205 will enter the field of view of camera system 1210.

Alternatively, the tracking data 1230, 1235 provided by system processor 1215 may be at least partially calculated in one camera system's motion tracking processor 24′ before being received by system processor 1215 which in turn provides the tracking data 1230, 1235 to the other camera system's motion tracking processor. In this alternative case, tracking data 1230, 1235 provided to one camera system's motion tracking processors 24′ by system processor 1215 may include digital video data relating to the other camera system, such as the other camera system's field of view boundary data. For example, tracking data 1230 provided to motion tracking processor 24′ of camera system 1205 by system processor 1215 may include field of view boundary data of camera system 1210 so that motion tracking processor 24′ of camera system 1205 may predict whether an object in the field of view of camera system 1205 will enter the field of view of camera system 1210.

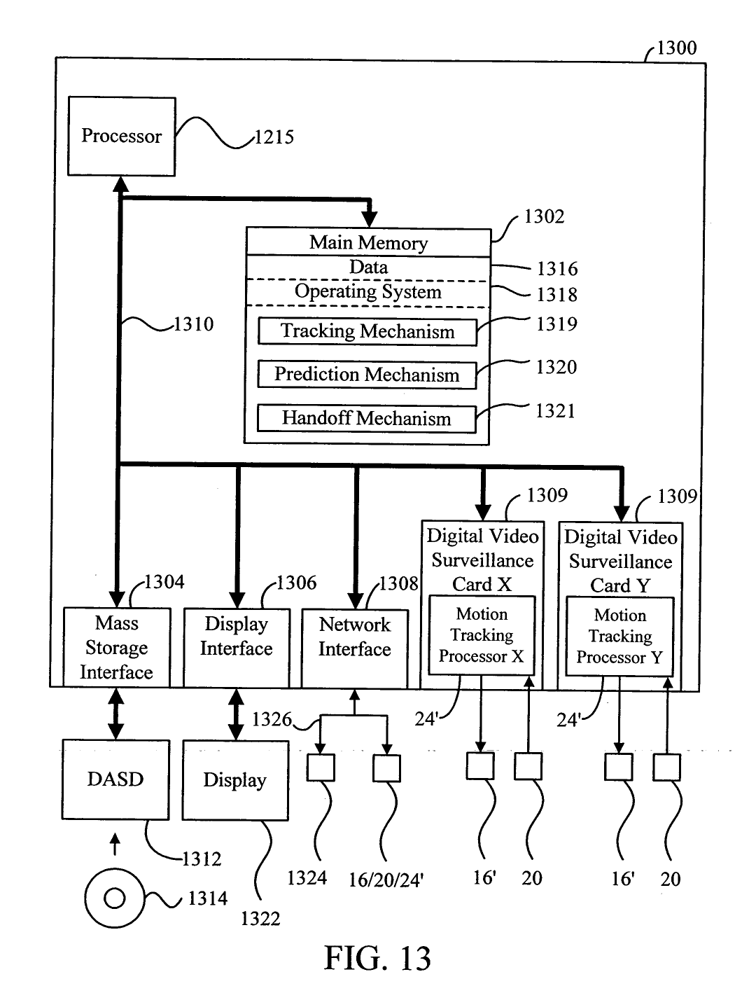

The motion tracking processors 24′ and system processor 1215 will now be described with reference to FIG. 13 in the context of a particular computer system 1300, i.e., an IBM iSeries computer system. However, those skilled in the art will appreciate that the method, system and program product of the present invention apply equally to any computer system, regardless of whether the computer system is a complicated multi-user computing apparatus, a single user workstation, or an embedded control system. The computer system 1300 is preferably present in one or more monitoring stations, which may be fixed and/or mobile.

As shown in FIG. 13, computer system 1300 comprises system processor 1215, a main memory 1302, a mass storage interface 1304, a display interface 1306, a network interface 1308, and two digital video surveillance cards 1309. These system components are interconnected through the use of a system bus 1310. Alternatively, digital video surveillance cards 1309 may be interconnected to the various system components and/or system bus 1310 through one or more other buses. Mass storage interface 1304 is used to connect mass storage devices (such as a direct access storage device 1312) to computer system 1300. One specific type of direct access storage device 1312 is a readable and writable CD ROM drive, which may store data to and read data from a CD ROM 1314.

Digital video surveillance cards 1309 each include a motion tracking processor 24′. One digital surveillance card 1309 includes a first motion tracking processor 24′ associated with a first video camera system 1205 (shown in FIG. 12). The other digital video surveillance card 1309 includes a second motion tracking processor 24′ associated with a second video camera system 1210 (shown in FIG. 12). For the sake of simplicity, only two digital video surveillance cards 1309 are shown in FIG. 13. Those skilled in the art will appreciate, however, that the present invention may be practiced using any number of digital video surveillance cards 1309. For example, one or more additional digital video surveillance cards 1309 may be included in computer system 1300 to accommodate additional video camera systems. The digital video surveillance cards 1309 may be separate from each other as shown in FIG. 13, or may be integrated as a single digital video surveillance card. In that case, motion tracking processors 24′ may be separate from each other or integrated with each other as a single processor resident on the single digital video surveillance card. Also, those of skill in the art will recognize that digital video surveillance cards 1309 may be omitted entirely, in favor of system processor 1215 performing the functions of motion tracking processors 24′.

Motion tracking processors 24′ resident on digital video surveillance cards 1309 are connected to the various system components via system bus 1310 and/or one or more other buses. In addition to motion tracking processors 24′, digital video surveillance cards 1309 may each include a video data processor 20 (shown in FIG. 12).

Main memory 1302 in accordance with the preferred embodiments contains data 1316, an operating system 1318, and a tracking mechanism 1319, a prediction mechanism 1320 and a handoff mechanism 1321. While these mechanisms are shown separate and discrete from operating system 1318 in FIG. 13, the preferred embodiments expressly extend to any or all of these mechanisms being implemented within the operating system 1318. In addition, any or all of tracking mechanism 1319, prediction mechanism 1320 and handoff mechanism 1321 could be implemented in application software, utilities, or other types of software within the scope of the preferred embodiments.

Computer system 1300 utilizes well known virtual addressing mechanisms that allow the programs of computer system 1300 to behave as if they have access to a large, single storage entity instead of access to multiple, smaller storage entities such as main memory 1302 and DASD device 1312. Therefore, while data 1316, operating system 1318, tracking mechanism 1319, prediction mechanism 1320 and handoff mechanism 1321 are shown to reside in main memory 1302, those skilled in the art will recognize that these items are not necessarily all completely contained in main memory 1302 at the same time. It should also be noted that the term “memory” is used herein to generically refer to the entire virtual memory of the computer system 1300, including one or more memories on digital video surveillance cards 1309.

Data 1316 represents any data that serves as input to or output from any program in computer system 1300. Operating system 1318 is a multitasking operating system known in the industry as OS/400; however, those skilled in the art will appreciate that the spirit and scope of the present invention is not limited to any one operating system.

System processor 1215 may be constructed from one or more microprocessors and/or integrated circuits. System processor 1215 executes program instructions stored in main memory 1302. In addition, motion tracking processors 24′ may execute program instructions stored in main memory 1302 by virtue of being resident on digital video surveillance cards 1309. Main memory 1302 stores programs and data that system processor 1215 and motion tracking processors 24′ may access. When computer system 1300 starts up, system processor 1215 initially executes the program instructions that make up operating system 1318. Operating system 1318 is a sophisticated program that manages the resources of computer system 1300. Some of these resources are system processor 1215, main memory 1302, mass storage interface 1304, display interface 1306, network interface 1308, digital surveillance cards 1309, and system bus 1310.

Although computer system 1300 is shown to contain only a single system processor and a single system bus, those skilled in the art will appreciate that the present invention may be practiced using a computer system that has multiple system processors and/or multiple buses. In addition, the interfaces that are used in the preferred embodiments each include separate, fully programmed microprocessors that are used to off-load compute-intensive processing from system processor 1215. However, those skilled in the art will appreciate that the present invention applies equally to computer systems that simply use I/O adapters to perform similar functions.

Display interface 1306 is used to directly connect one or more displays 1322 to computer system 1300. These displays 1322, which may be non-intelligent (i.e., dumb) terminals or fully programmable workstations, are used to allow system administrators and users (also referred to herein as “operators”) to communicate with computer system 1300. Note, however, that while display interface 1306 is provided to support communication with one or more displays 1322, computer system 1300 does not necessarily require a display 1322, because all needed interaction with users and processes may occur via network interface 1308.

Network interface 1308 is used to connect other computer systems and/or workstations (e.g., 1324 in FIG. 13) to computer system 1300 across a network 1326. In addition, network interface 1308 may be used to connect PTZ adjustment mechanisms 16′, video data processors 20, and/or motion tracking processors 24′ (in lieu of connection via digital surveillance cards 1309) to computer system 1300 across network 1326. Likewise, if video data processors 20 are resident on digital surveillance cards 1309 or elsewhere in computer system 1300, network interface 1308 also may be used to connect video cameras 12 (shown in FIG. 12) to computer system 1300. The present invention applies equally no matter how computer system 1300 may be connected to other computer systems and/or workstations, video cameras 12, PTZ adjustment mechanism 16′, video data processors 20, and/or motion tracking processors 24′, regardless of whether the network connection 1326 is made using present-day analog and/or digital techniques or via some networking mechanism of the future. In addition, many different network protocols can be used to implement a network. These protocols are specialized computer programs that allow computers to communicate across network 1326. TCP/IP (Transmission Control Protocol/Internet Protocol) is an example of a suitable network protocol.

Alternatively, I/O adapters may be used to connect PTZ adjustment mechanisms 16′, video data processors 20, and/or motion tracking processors 24′ (in lieu of connection via digital surveillance cards 1309) to computer system 1300. In addition, if video data processors 20 are resident on digital surveillance cards 1309 or elsewhere in computer system 1300, I/O adapters may be used to connect video cameras 12 (shown in FIG. 12) to computer system 1300. For example, video cameras 12, PTZ adjustment mechanisms 16′ and/or video data processor 20 may be connected to computer system 1300 using an I/O adapter on digital video surveillance cards 1309. In a variation of this alternative, a system I/O adapter may be used to connect video cameras 12, PTZ adjustment mechanisms 16′, video data processors 20, and/or motion tracking processors 24′ (in lieu of connection via digital surveillance cards 1309) through system bus 1310.

At this point, it is important to note that while the present invention has been and will be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g., 1314 of FIG. 13), and transmission type media such as digital and analog communications links.

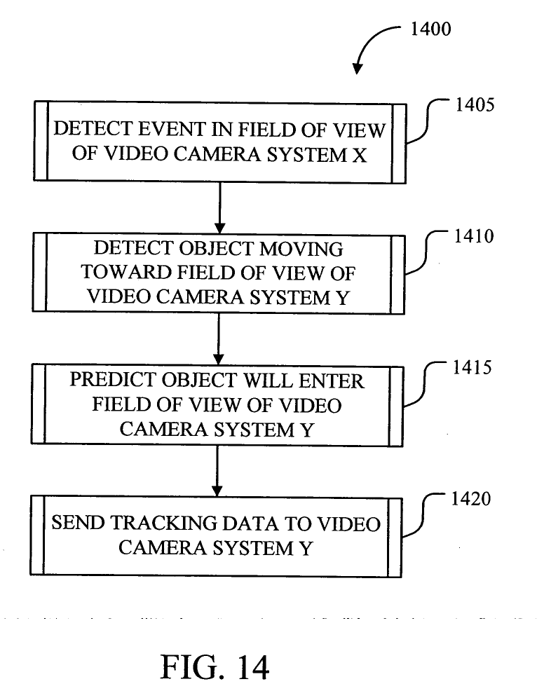

FIG. 14 is a flow diagram showing a high level overview of a method 1400 in accordance with the preferred embodiments that allows a plurality of video cameras to track an object using motion vector data. Method 1400 begins with the detection of an event (step 1405) in the field of view of video camera system 1205 (shown in FIG. 12). Next, method 1400 detects (at step 1410) that an object associated with the detected event is moving toward the field of view of video camera system 1210 (shown in FIG. 12). The detection of step 1410 is based on motion vector data. Method 1400 then predicts (at step 1415) that the object will enter the field of view of video camera system 1210. The prediction of step 1415 is based on motion vector data. Finally, method 1400 transmits (at step 1420) tracking data to video camera system 1210.

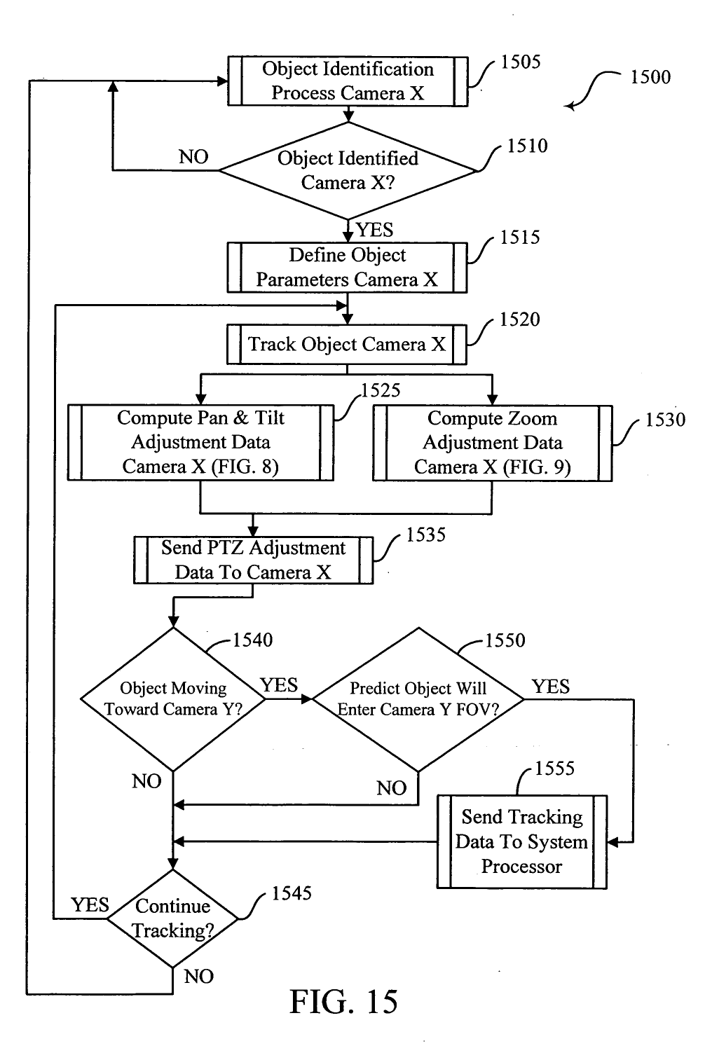

FIG. 15 shows a method 1500 performed by video camera systems 1205, 1210 (shown in FIG. 12) in accordance with the preferred embodiments. Initially, an object identification process is performed (step 1505). Any conventional object identification process may be utilized in step 1505. For example, conventional motion detection processors typically perform object identification. Next, method 1500 determines whether an object was identified (step 1510). If an object was not identified (step 1510=NO), method 1500 loops back to step 1505. On the other hand, if an object was detected (step 1510=YES), method 1500 continues by defining object parameters (step 1515). Step 1515 is conventional, but is briefly described in the discussion that follows. The object parameters defined in step 1515 include object boundary, object size and object center point, as well as camera initial focal length for optimal object viewing. The object parameters may be based on either individual pixels or groups of pixels, such as an MPEG macroblock. The object center point may be a centroid or the center of an area of highest interest, such as the center of a face when tracking a person. The method 1500 continues by tracking the object based on location and motion vectors (step 1520). Steps 1505, 1510, 1515 and 1520 may be executed by video data processors 20 (shown in FIG. 12) and/or motion tracking processors 24′ (shown in FIG. 12). If one or more of these steps is executed by video data processors 20, video data generated by video data processors 20 in the execution of each such step are provided to motion tracking processors 24′. On the other hand, if one or more of these steps is executed by motion tracking processors 24′, video data processors 20 provide any video data to motion tracking processors 24′ necessary for execution of each such step.

Method 1500 continues by computing camera pan and tilt adjustment data (step 1525) and computing camera zoom adjustment data (step 1530). Steps 1525 and 1530 are described in detail above with respect to the single camera embodiment. In the preferred embodiments, all adjustments assume constant velocity or acceleration of the object to determine the next camera location. However, those skilled in the art will appreciate that the present invention applies equally to adjustments made without these assumptions. The pan and tilt adjustment data are calculated relative to the object center point and the center point of the camera field of view. The zoom adjustment data are based on net contraction or expansion of the object boundary. Preferably, steps 1525 and 1530 are executed concurrently (in a multitasking fashion) as shown in FIG. 15. However, those skilled in the art will appreciate that the present invention may be practiced by executing steps 1525 and 1530 sequentially or as a combined single step. In addition, those skilled in the art will appreciate that the present invention may be practiced by omitting one of steps 1525 and 1530. Those skilled in the art will also appreciate that the present invention may be practiced by calculating any combination of pan, tilt and/or zoom adjustment data. Steps 1525 and 1530 are executed by motion tracking processors 24′ (shown in FIG. 12). Video data processors 20 (shown in FIG. 12) provide video data to motion tracking processors 24′ necessary for execution of these steps.

Having calculated the pan, tilt and/or zoom adjustment data, method 1500 proceeds (step 1535) to send the pan, tilt and/or adjustment data to PTZ adjustment mechanisms 16′ (shown in FIG. 12) of video cameras 12 (shown in FIG. 12). Step 1535 is executed by motion tracking processors 24′ (shown in FIG. 12). The tracking mechanism 1319 (shown in FIG. 13) preferably includes program instructions that at least correspond to steps 1525, 1530 and 1535.

Method 1500 then determines whether the object is moving toward another camera system's field of view (step 1540). The determination of 1540 is based on motion vector data. In one embodiment, the pan, tilt and/or zoom adjustment data calculated in steps 1525 and 1530 may be used along with knowledge of other camera system's field of view boundary data. In this embodiment, step 1540 may determine whether the predicted camera pan and tilt adjustments mv_{camera}(n+1) and/or estimated zoom factor ZFₑₛₜ(n+1) point toward the other camera system's field of view boundary. In another embodiment, motion vector data from video data processors 20 (shown in FIG. 12) may be used along with knowledge of other camera system's field of view boundary data. Preferably, step 1540 is executed by motion tracking processors 24′ (shown in FIG. 12). However, step 1540 may be executed by video data processors 20 or system processor 1215 (shown in FIG. 12).

If the object is determined not to be moving toward another camera system's field of view (step 1540=NO), method continues by determining whether tracking is to continue (step 1545). If tracking is to continue (step 1545=YES), method 1500 loops back to step 1520. On the other hand, if tracking is not to continue (step 1540=NO), method 1500 loops back to step 1505. As mentioned above, step 1540 may be executed by video data processors 20, motion tracking processors 24′, and or system processor 1215. If this step is executed by video data processors 20′, video data generated by video data processors 20 in the execution of the step are provided to motion tracking processors 24′. On the other hand, if this step is executed by motion tracking processors 24′, video data processors 20 provides any video data to motion tracking processors 24′ necessary for execution of the step.

If the object is determined to be moving toward another camera system's field of view (step 1540=YES), method 1500 continues by predicting whether the object will enter the other camera system's field of view (step 1550). The prediction of 1550 is based on motion vector data. In one embodiment, the pan, tilt and/or zoom adjustment data calculated in steps 1525 and 1530 may be used along with knowledge of the camera center location and the other camera system's field of view boundary data. Step 1550 may, for example, determine whether the predicted camera pan and tilt adjustments mv_{camera}(n+1) extend to the other camera system's field of view boundary. Alternatively, or in addition, step 1550 may determine whether the estimated focal length f1ₑₛₜ(n+1) extend to the other camera system's field of view boundary. Preferably, step 1550 is executed by motion tracking processors 24′ (shown in FIG. 12). However, step 1550 may be executed by video system processor 1215 (shown in FIG. 12). The prediction mechanism 1320 (shown in FIG. 13) preferably includes program instructions that at least correspond to step 1550.

If the object is predicted not to enter the other camera systems field of view (step 1550=NO), method 1500 continues to step 1545 and determines whether tracking is to continue.

If the object is predicted to enter the other camera systems field of view (step 1550=YES), method 1500 proceeds (at step 1555) to send tracking data to the system processor. Step 1555 is executed by the motion tracking processors 24′ (shown in FIG. 12). This tracking data sent to the system processor 1215 (shown in FIG. 12) may include at least one of object motion vector data, object shrinkage/expansion data, and other digital video data. After sending the tracking data to the system processor at step 1555, method 1500 continues to step 1545 and determines whether tracking is to continue.

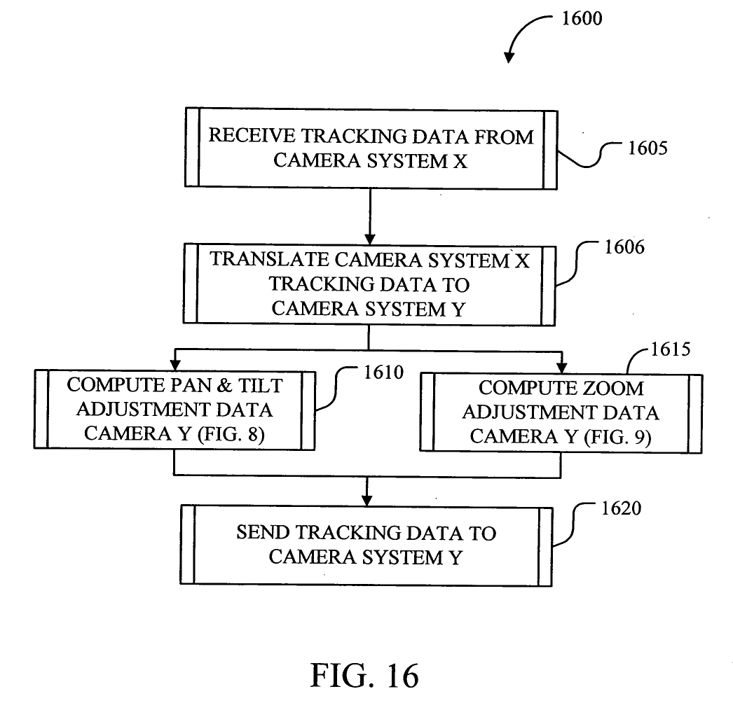

FIG. 16 shows a method 1600 performed by system processor 1215 (shown in FIG. 12) in accordance with the preferred embodiments. Initially, tracking data are received by the system processor from one camera system's motion tracking processor (step 1605). Next, method 1600 continues with the system processor translating tracking data received from camera system X into tracking data for camera system Y (step 1606). Then, method 1600 continues with the system processor computing camera pan and tilt adjustment data (step 1610) and computing camera zoom adjustment data (step 1615) for the other camera system. For example, temporarily referring back to FIG. 12, system processor 1215 receives tracking data 1230 from motion tracking processor 24′ of camera system 1205 (step 1605) and then system processor 1215 calculates pan, tilt and/or zoom adjustment data 1225 for camera system 1210 (steps 1610 and 1615). The calculations used in steps 1610 and 1615 are described in detail above with respect to the single camera embodiment. Finally, method 1600 continues with the system processor sending tracking data to the other camera system (step 1620). This tracking data sent to the other camera system may include at least one of pan, tilt and/or zoom adjustment data; object motion vector data; object shrinkage/expansion data; and other digital video data. Continuing the example above, and again temporarily referring back to FIG. 12, system processor 1215 sends pan, tilt and/or zoom adjustment data 1225 to PTZ adjustment mechanism 16′ of camera system 1210; and tracking data 1235 to motion tracking processor 24′ of camera system 1210. The handoff mechanism 1319 (shown in FIG. 13) preferably includes program instructions that at least correspond to steps 1605, 1610, 1615 and 1620.

The embodiments and examples set forth herein were presented in order to best explain the present invention and its practical application and to thereby enable those skilled in the art to make and use the invention. However, those skilled in the art will recognize that the foregoing description and examples have been presented for the purpose of illustration and example only. The description as set forth is not intended to be exhaustive or to limit the invention to the precise form disclosed. Many modifications and variations are possible without departing from the spirit and scope of the forthcoming claims. For example, the preferred embodiments expressly extend to mobile video camera systems as well as fixed video camera systems. In another modification, non-constant acceleration may be accounted for by expanding object motion history data across more than two past reference fields. This modification increases tracking accuracy, but with a tradeoff of a requirement for more history data storage. In yet another modification, the tracking time interval may be extended beyond every field, e.g., 1/30^{th} second or ½ second rather than 1/60^{th} second. This modification reduces the history data storage requirement, but with a tradeoff of decreased tracking accuracy.

What is claimed is:

1. A method for a plurality of cameras to track an object using motion vector data, the method comprising the steps of:
a first camera system having a first camera with a first field of view providing a sequence of video fields;
providing motion vector data for an object in the first field of view based on the sequence of video fields provided by the first camera;
predicting whether the object will enter a second field of view based on the motion vector data;
a second camera system having a second camera with the second field of view providing a sequence of video fields;
if the predicting step predicts that the object will enter the second field of view, providing tracking data to the second camera system.

2. The method as recited in claim 1, wherein the step of providing tracking data to the second camera system includes the step of providing at least one of pan, tilt and zoom adjustment data to a PTZ adjustment mechanism of the second camera system.

3. The method as recited in claim 1, wherein the step of providing tracking data to the second camera system includes the step of providing at least one of pan/tilt motion vector data, zoom factor data and shrinkage/expansion data to a motion tracking processor of the second camera system.

4. The method as recited in claim 1, wherein the step of providing tracking data to the second camera system includes the step of providing at least one of pan/tilt motion vector data, zoom factor data, and shrinkage/expansion data to the motion tracking processor of the second camera system, and pan, tilt and/or zoom adjustment data to a PTZ adjustment mechanism of the second camera system.

5. The method as recited in claim 1, wherein the step of providing motion vector data is performed by an MPEG compression processor of the first camera system that provides the motion vector data at a macroblock level.

6. The method as recited in claim 5, wherein the step of predicting whether the object will enter the second field of view is performed by a motion tracking processor of the first camera system that receives the motion vector data at a macroblock level from the MPEG compression processor of the first camera system.

7. The method as recited in claim 1, wherein the step of providing motion vector data is performed by a pre-processor of the first camera system that provides the motion vector data at a pixel level.

8. The method as recited in claim 7, wherein the step of predicting whether the object will enter the second field is performed by a motion tracking processor of the first camera system that receives the motion vector data at a pixel level from the pre-processor of the first camera system.

9. The method as recited in claim 1, further comprising the steps of:
detecting whether an event has occurred in the first field of view, wherein the object is associated with the event;
detecting whether the object has moved toward the second field of view based on the motion vector data.

10. The method as recited in claim 1, wherein the step of providing tracking data to the second camera system is performed by a system processor receiving tracking data from a motion tracking processor of the first camera system.

11. The method as recited in claim 10, wherein the step of providing tracking data to the second camera system includes the step of providing at least one of pan/tilt motion vector data, zoom factor data, shrinkage/expansion data to the motion tracking processor of the second camera system, and pan, tilt and/or zoom adjustment data to a PTZ adjustment mechanism of the second camera system.

12. The method as recited in claim 1, further comprising the step of:
providing at least one of pan, tilt and zoom adjustment data to a PTZ adjustment mechanism of the first camera system.

13. A system for a plurality of cameras to track an object using motion vector data, comprising:
a first camera system having a first camera with a first field of view providing a sequence of video fields, a video data processor providing motion vector data for an object in the first field of view based on the sequence of video fields provided by the first camera, and a motion tracking processor predicting whether the object will enter a second field of view based on the motion vector data provided by the video data processor;
a second camera system having a second camera with the second field of view; and
a system processor providing tracking data to the second camera system if the motion tracking processor of the first camera system predicts that the object will enter the second field of view.

14. The system as recited in claim 13, wherein the system processor provides at least one of pan, tilt and zoom adjustment data to a PTZ adjustment mechanism of the second camera system if the motion tracking processor of the first camera system predicts that the object will enter the second field of view.

15. The system as recited in claim 13, wherein the system processor provides at least one of pan/tilt motion vector data, zoom factor data and shrinkage/expansion data to a motion tracking processor of the second camera system if the motion tracking processor of the first camera system predicts that the object will enter the second field of view.

16. The system as recited in claim 13, wherein the system processor provides at least one of pan/tilt motion vector data, zoom factor data, and shrinkage/expansion data to the motion tracking processor of the second camera system, and pan, tilt and/or zoom adjustment data to a PTZ adjustment mechanism of the second camera system if the motion tracking processor of the first camera system predicts that the object will enter the second field of view.

17. The system as recited in claim 13, wherein the video data processor of the first camera system includes an MPEG compression processor that provides the motion vector data at a macroblock level to the motion tracking processor of the first camera system.

18. The system as recited in claim 13, wherein the video data processor of the first camera system includes a pre-processor that provides the motion vector data at a pixel level to the motion tracking processor of the first camera system.

19. The system as recited in claim 13, wherein the motion tracking processor provides at least one of pan, tilt and zoom adjustment data to a PTZ adjustment mechanism of the first camera system.

20. A program product, comprising:
(A) a prediction mechanism that predicts whether an object in a first field of view covered by a first camera system will enter a second field of view covered by a second camera system based on motion vector data provided by the first camera system;
(B) a handoff mechanism that provides tracking data to the second camera system if the prediction mechanism predicts that the object will enter the second field of view;
(C) computer-readable signal bearing media bearing (A) and (B).

21. The program product as recited in claim 20, wherein the signal bearing media comprises recordable media.

22. The program product as recited in claim 20, wherein the signal bearing media comprises transmission media.

23. The program product as recited in claim 20, wherein the prediction mechanism is executed by a motion tracking processor of the first camera system.

24. The program product as recited in claim 23, wherein the handoff mechanism is executed by a system processor receiving tracking data from the motion tracking processor of the first camera system.

25. The program product as recited in claim 20, wherein the handoff mechanism provides at least one of pan, tilt and zoom adjustment data to a PTZ adjustment mechanism of the second camera system if the prediction mechanism predicts that the object will enter the second field of view.

26. The program product as recited in claim 20, wherein the handoff mechanism provides at least one of pan/tilt motion vector data, zoom factor data, and shrinkage/expansion data to a motion tracking processor of the second camera system.

27. A program product, comprising:
(A) a prediction mechanism that predicts whether an object in a first field of view covered by a first camera system will enter a second field of view covered by a second camera system based on motion vector data provided by the first camera system;
(B) a handoff mechanism that provides tracking data to the second camera system if the prediction mechanism predicts that the object will enter the second field of view;
(C) a tracking mechanism that provides at least one of pan, tilt and zoom adjustment data to a PTZ adjustment mechanism of the first camera system;
(D) computer-readable signal bearing media bearing (A), (B) and (C).

28. The program product as recited in claim 27, wherein the signal bearing media comprises recordable media.

29. The program product as recited in claim 27, wherein the signal bearing media comprises transmission media.

30. The program product as recited in claim 27, wherein the tracking mechanism is executed by a motion tracking processor of the first camera system.
